(19) United States
(12) Patent Application Publication
(10) Pub. No.: US 2026/0067833 A1
(43) Pub. Date: Mar. 5, 2026

(54) SIDELINK AUTOMATIC GAIN CONTROL

(71) Applicant: QUALCOMM Incorporated, San Diego, CA (US)

(72) Inventors: Shijun WU, San Diego, CA (US); Kapil GULATI, Belle Mead, NJ (US)

(21) Appl. No.: 18/816,553

(22) Filed: Aug. 27, 2024

(51) Int. Cl. H04W 52/52

(52) U.S. Cl. CPC H04W 52/52

(57) ABSTRACT

Various aspects of the present disclosure generally relate to wireless communication. Some aspects relate to a configurable automatic gain control (AGC) procedure for sidelink communications. A receiving device, a transmitting device, and/or a network node may determine whether AGC training is to be performed for sidelink communications. For example, the receiving device, the transmitting device, and/or the network node may determine whether resources dedicated to the AGC procedure may be used for communicating other information, such as data and/or control information. The receiving device, the transmitting device, and/or the network node may identify an AGC configuration for whether an AGC resource, of a set of resources for communicating one or more signals, includes an AGC message for performing the AGC procedure. The transmitting device and/or the receiving device may communicate the AGC message, the data message, and/or the control message via the AGC resource in accordance with the AGC configuration.

### FIELD OF THE DISCLOSURE

Aspects of the present disclosure generally relate to wireless communication and specifically relate to techniques, apparatuses, and methods associated with sidelink automatic gain control.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, intelligent transportation system (ITS) spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

Some wireless communications systems may support device-to-device (D2D) communications, via sidelink, for signaling between multiple wireless communication devices, such as multiple user equipments (UE). A receiving device (for example, a receiving UE) may experience variation in received signal power of one or more signals communicated by respective transmitting devices (for example, a transmitting UE) via one or more resources (for example, one or more slots encompassing a quantity of symbols). For example, the receiving device may receive signals from different devices transmitting during respective time resources. In such examples, when the different devices are located at various distances from the receiving device, the received signal power from the different devices may vary. The receiving device and the one or more transmitting devices may perform a gain control procedure, such as an automatic gain control (AGC) procedure, to address the varying received signal power at the receiving device. The AGC procedure may include communicating an AGC resource (for example, including an AGC symbol) with each communication from the transmitting devices. For example, the receiving device and/or the transmitting devices may dedicate at least a portion of each respective resource to the AGC procedure even when receive power variations are insignificant. Default performance of an AGC procedure by the receiving device and/or one or more transmitting devices may be an over design in some scenarios. Hence, performing AGC for each respective time resource can incur a fixed and significant use of time-frequency resources.

### SUMMARY

Some aspects described herein relate to a first user equipment (UE) for wireless communication. The first UE may include a processing system that includes one or more processors and one or more memories coupled with the one or more processors. The processing system may be configured to cause the first UE to identify a gain control configuration associated with a set of time-frequency resources for communicating one or more signals between the first UE and a second UE. The processing system may be configured to cause the first UE to transmit, to the second UE, an indication of whether the set of time-frequency resources includes a gain control message in accordance with the gain control configuration. The processing system may be configured to cause the first UE to transmit, via the set of time-frequency resources, the one or more signals in accordance with whether the set of time-frequency resources includes the gain control message.

Some aspects described herein relate to a second UE for wireless communication. The second UE may include a processing system that includes one or more processors and one or more memories coupled with the one or more processors. The processing system may be configured to cause the second UE to receive, from a first UE, an indication of whether a set of time-frequency resources, for communicating one or more signals between the second UE and the first UE, includes a gain control message. The processing system may be configured to cause the second UE to receive, during the set of time-frequency resources, the one or more signals in accordance with whether the set of time-frequency resources includes the gain control message.

Some aspects described herein relate to a network node for wireless communication. The network node may include a processing system that includes one or more processors and one or more memories coupled with the one or more processors. The processing system may be configured to cause the network node to transmit, to at least one of a first UE or a second UE, an indication of a set of time-frequency resources for communicating one or more signals between the first UE and the second UE. The processing system may be configured to cause the network node to transmit, to the first UE, a gain control configuration associated with the set of time-frequency resources.

Some aspects described herein relate to a method of wireless communication performed by a first UE. The method may include identifying a gain control configuration associated with a set of time-frequency resources for communicating one or more signals between the first UE and a second UE. The method may include transmitting, to the second UE, an indication of whether the set of time-frequency resources includes a gain control message in accordance with the gain control configuration. The method may include transmitting, via the set of time-frequency resources, the one or more signals in accordance with whether the set of time-frequency resources includes the gain control message.

Some aspects described herein relate to a method of wireless communication performed by a second UE. The method may include receiving, from a first UE, an indication of whether a set of time-frequency resources, for communicating one or more signals between the second UE and the first UE, includes a gain control message. The method may include receiving, during the set of time-frequency resources, the one or more signals in accordance with whether the set of time-frequency resources includes the gain control message.

Some aspects described herein relate to a method of wireless communication performed by a network node. The method may include transmitting, to at least one of a first UE or a second UE, an indication of a set of time-frequency resources for communicating one or more signals between the first UE and the second UE. The method may include transmitting, to the first UE, a gain control configuration associated with the set of time-frequency resources.

Some aspects described herein relate to a non-transitory computer-readable medium that stores a set of instructions for wireless communication by a first UE. The set of instructions, when executed by one or more processors of the first UE, may cause the first UE to identify a gain control configuration associated with a set of time-frequency resources for communicating one or more signals between the first UE and a second UE. The set of instructions, when executed by one or more processors of the first UE, may cause the UE to transmit, to the second UE, an indication of whether the set of time-frequency resources includes a gain control message in accordance with the gain control configuration. The set of instructions, when executed by one or more processors of the first UE, may cause the first UE to transmit, via the set of time-frequency resources, the one or more signals in accordance with whether the set of time-frequency resources includes the gain control message.

Some aspects described herein relate to a non-transitory computer-readable medium that stores a set of instructions for wireless communication by a second UE. The set of instructions, when executed by one or more processors of the second UE, may cause the second UE to receive, from a first UE, an indication of whether a set of time-frequency resources, for communicating one or more signals between the second UE and the first UE, includes a gain control message. The set of instructions, when executed by one or more processors of the second UE, may cause the second UE to receive, during the set of time-frequency resources, the one or more signals in accordance with whether the set of time-frequency resources includes the gain control message.

Some aspects described herein relate to a non-transitory computer-readable medium that stores a set of instructions for wireless communication by a network node. The set of instructions, when executed by one or more processors of the network node, may cause the network node to transmit, to at least one of a first UE or a second UE, an indication of a set of time-frequency resources for communicating one or more signals between the first UE and the second UE. The set of instructions, when executed by one or more processors of the network node, may cause the network node to transmit, to the first UE, a gain control configuration associated with the set of time-frequency resources.

Some aspects described herein relate to an apparatus for wireless communication. The apparatus may include means for identifying a gain control configuration associated with a set of time-frequency resources for communicating one or more signals between the apparatus and a UE. The apparatus may include means for transmitting, to the second UE, an indication of whether the set of time-frequency resources includes a gain control message in accordance with the gain control configuration. The apparatus may include means for transmitting, via the set of time-frequency resources, the one or more signals in accordance with whether the set of time-frequency resources includes the gain control message.

Some aspects described herein relate to an apparatus for wireless communication. The apparatus may include means for receiving, from a first UE, an indication of whether a set of time-frequency resources, for communicating one or more signals between the apparatus and the UE, includes a gain control message. The apparatus may include means for receiving, during the set of time-frequency resources, the one or more signals in accordance with whether the set of time-frequency resources includes the gain control message.

Some aspects described herein relate to an apparatus for wireless communication. The apparatus may include means for transmitting, to at least one of a first UE or a second UE, an indication of a set of time-frequency resources for communicating one or more signals between the first UE and the second UE. The apparatus may include means for transmitting, to the first UE, a gain control configuration associated with the set of time-frequency resources.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example UE in a wireless communication network in accordance with the present disclosure.

FIG. 3 is a diagram illustrating an example disaggregated base station architecture in accordance with the present disclosure.

FIG. 4 is a diagram illustrating an example of sidelink communications in accordance with the present disclosure.

FIG. 5 is a diagram illustrating an example of sidelink communications and access link communications in accordance with the present disclosure.

FIG. 6 is a diagram illustrating examples associated with automatic gain control (AGC) training for sidelink communications in accordance with the present disclosure.

FIG. 7 is a diagram of an example associated with sidelink gain control in accordance with the present disclosure.

FIG. 8 is a diagram illustrating an example of a configurable AGC resource in accordance with the present disclosure.

FIG. 9 is a flowchart illustrating an example process performed, for example, at a UE or an apparatus of a UE that supports sidelink AGC in accordance with the present disclosure.

FIG. 10 is a flowchart illustrating an example process performed, for example, at a UE or an apparatus of a UE that supports sidelink AGC in accordance with the present disclosure.

FIG. 11 is a flowchart illustrating an example process performed, for example, at a network node or an apparatus of a network node that supports sidelink AGC in accordance with the present disclosure.

FIG. 12 is a diagram of an example apparatus for wireless communication that supports sidelink AGC in accordance with the present disclosure.

FIG. 13 is a diagram of an example apparatus for wireless communication that supports configurable sidelink AGC in accordance with the present disclosure.

FIG. 14 is a diagram of an example apparatus for wireless communication that supports configurable sidelink AGC in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some wireless communications systems may support sidelink communications, such as vehicle-to-everything (V2X) communications. In some examples, aspects of sidelink communications were designed for V2X use cases. For example, V2X communications may include communications between a user equipment (UE) (for example, mounted on a vehicle) and other UEs (for example, other vehicles, vulnerable road users) which may primarily include broadcast communications. Even though V2X communications may include other cast types, such as unicast, most sidelink design is directed to broadcast enhancements for devices associated with high mobility. As a result, existing sidelink techniques may not be designed with unicast communications as a primary use case. For example, V2X communications may primarily be deployed in a distributed manner and scheduled autonomously by a UE, via broadcast (for example, via licensed and/or unlicensed spectrum bands, and/or via intelligent transportation system (ITS) spectrum bands).

Some such sidelink communications may include a receiving device (for example, a UE) receiving a communication from a transmitter (for example, one or more UEs and/or a network node). The receiving device may perform automatic gain control (AGC) for the reception of the communication. For example, the receiving device may regulate a received signal strength of the communication by performing outer loop AGC on the communication after a radio frequency (RF) chain of the receiver and prior to the communication being provided to an analog-to-digital converter for analog-to-digital conversion. The outer loop AGC may include a closed feedback loop that measures a signal strength of the communication after analog-to-digital conversion, and modifies the RF gain parameter based on or otherwise associated with the measurement. If the signal strength of the communication is weak (for example, below a threshold signal strength), the outer loop AGC may modify the RF gain parameter to boost one or more receiver gain stages in the RF chain to reduce noise and improve the signal-to-noise ratio (SNR) of the transmission of the communication. If the signal strength of the communication is strong, the outer loop AGC may modify the RF gain parameter to attenuate the one or more receiver gain stages in the RF chain to reduce signal clipping and/or nonlinear degradations of the communication.

In sidelink communications, a receiving device may experience variation in received signal power of one or more signals communicated by respective transmitting devices (for example, a transmitting UE) via one or more resource sets (for example, one or more slots encompassing a quantity of symbols). For example, the receiving device may receive signals from different devices transmitting during respective resource sets. In such examples, when the different devices are located at various distances from the receiving device, the received signal power from the different devices may vary. In some examples, the mobility of the transmitting device and/or the receiving device may contribute to signal power variations. Devices such as V2X UEs may be likely to be associated with high mobility. Further, received signal power variations may cause a degradation in communications, such as reduced SNR (for example, causing signal to be harder to distinguish from noise), increased bit error rate, increased susceptibility to interference, connection drops, higher power consumption to compensate for low received power, among other examples. As a result, a portion of each resource may be reserved to perform AGC for sidelink communications by default.

For example, the receiving device and the one or more transmitting devices may perform an AGC procedure to address the varying received signal power at the receiving device for each sidelink communication. The AGC procedure may include communicating an AGC message via one or more AGC resources with each communication from transmitting devices. In such examples, the receiving device and/or the transmitting device may dedicate at least a portion of each respective resource set to the AGC procedure even when receive power variations are insignificant. For example, there may be scenarios where performing an AGC procedure (and thus dedicating resources for the AGC procedure) may be superfluous. For example, when a power variation between two resource sets (for example, slots) is (or expected to be) small and/or insignificant (for example, within a dynamic range, or unlikely to cause a noticeable degradation in communication quality), performing the AGC procedure may be an inefficient use of resources. As a result, the default performance of an AGC procedure by the receiving device and/or one or more transmitting devices may consume resources without providing a significant benefit to the quality of sidelink communications, especially in examples where receive power variations are insignificant or are expected to be insignificant.

However, as use cases for unicast sidelink communication (for example, between a wearable UE, such as a smart watch and a handheld UE, such as a cellphone; extended reality (XR) traffic over sidelink, among other examples) expand, sidelink for some unicast use cases may be deployed in a licensed band. Thus, network-managed resource allocation may become more applicable in sidelink, and per-resource AGC may become less relevant, especially for unicast sidelink communications associated with lower mobility.

Various aspects relate generally to a configurable AGC procedure. Some aspects more specifically relate to enabling and/or disabling resources dedicated to performing the AGC procedure. For example, one or more of a receiving device, a transmitting device, and/or a network node may determine whether AGC would be beneficial to perform. In some aspects, if an expected receive power of a later-scheduled transmission is similar to that of an earlier transmission, one or more of the receiving device, the transmitting device, and/or the network node may determine that the resources previously dedicated to the AGC procedure may be used for communicating other information, such as sidelink data and/or control information.

For example, a transmitting (Tx) UE may identify a gain control configuration associated with a set of time-frequency resources for communicating one or more signals between the Tx UE and a receiving (Rx) UE. The Tx UE may transmit, and the Rx UE may receive, an indication of whether the set of time-frequency resources includes a gain control message in accordance with the gain control configuration. The Tx UE may transmit, and the Rx UE may receive, via the set of time-frequency resources, the one or more signals in accordance with whether the set of time-frequency resources includes the gain control message.

Some aspects more specifically relate to the Tx UE receiving, from a network node and/or the Rx UE, an indication of the gain control configuration. In some other aspects, the Tx UE and/or the Rx UE may identify the gain control configuration in accordance with one or more parameters associated with communications between the Tx UE and the Rx UE. In some aspects, communicating the one or more signals in accordance with whether the set of time-frequency resources includes the gain control message may include the Rx UE receiving the gain control message via a first time-frequency resource of the set of time-frequency resources and performing a gain control procedure for the one or more signals. In some other aspects, communicating the one or more signals in accordance with whether the set of time-frequency resources includes the gain control message may include refraining from performing a gain control procedure for the one or more signals and receiving a data message and/or a control message via a resource associated with (for example, previously reserved for) the gain control message.

Particular aspects of the subject matter described in this disclosure can be implemented to realize one or more of the following potential advantages. In some examples, the described techniques can be used to conserve resources and improve system performance. For example, by identifying the gain control configuration by the Tx UE, the described techniques may be used to increase channel reliability and more efficiently utilize resources by taking into account communication conditions between the Tx UE and the Rx UE and/or communications scheduled to be transmitted by the Tx UE when determining whether to transmit an AGC message in the AGC symbol. Further, the Tx UE may determine to override an AGC configuration communicated by the network node, which may conserve resources by refraining from performing AGC training when one or more conditions observed by the Tx UE indicate AGC may be circumvented. Additionally or alternatively, the Tx UE may determine to override an AGC configuration communicated by the network node, which may increase signal quality by enabling AGC training in scenarios where the Tx UE identifies that the received power at the Rx UE may vary significantly due to one or more conditions observed by the Tx UE.

By identifying and communicating the gain control configuration by the network node, the described techniques may be used to decrease a likelihood that AGC is performed superfluously or insufficiently, because the network node may take the communication schedules of multiple Tx UEs into account when identifying the gain control configuration. By identifying the gain control configuration by the Rx UE, the described techniques may be used to conserve resources by refraining from performing AGC training in scenarios where AGC training would provide little to no benefit, thereby conserving energy expended by the Rx UE. By the Rx UE receiving the indication of whether the set of resources includes the gain control message, the described techniques may be used to conserve resources by refraining from blind decoding the AGC resource to receive either an AGC message, a data message, and/or a control message. In some aspects, by the Tx UE and the Rx UE communicating an indication of whether the set of time frequency resources includes a gain control message, the described techniques may be used to avoid decoding errors associated with receiving a data message and/or a control message via an AGC resource.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, ITS spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, XR and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

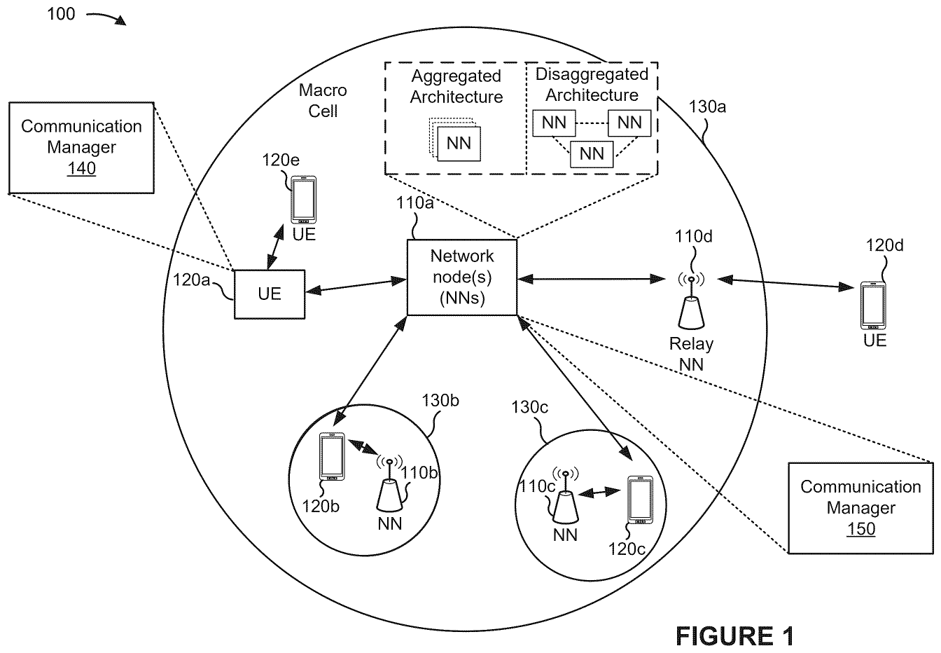

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on or otherwise associated with user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, in accordance with a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move in accordance with the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on or otherwise associated with changing network conditions in the wireless communication network 100 and/or based on or otherwise associated with the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified in accordance with different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an uplink (UL) communication to a network node 110, which then transmits the data to the UE 120e in a downlink (DL) communication. In various examples, the UEs 120 may transmit and receive sidelink communications using peer-to-peer (P2P) communication protocols, device-to-device (D2D) communication protocols, V2X communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a first UE 120 may include a communication manager 140. As described in more detail elsewhere herein, the communication manager 140 may identify a gain control configuration associated with a set of time-frequency resources for communicating one or more signals between the first UE and a second UE; transmit, to the second UE, an indication of whether the set of time-frequency resources includes a gain control message in accordance with the gain control configuration; and transmit, via the set of time-frequency resources, the one or more signals in accordance with whether the set of time-frequency resources includes the gain control message. Additionally or alternatively, the communication manager 140 may perform one or more other operations described herein.

In some aspects, a second UE 120 may include a communication manager 140. As described in more detail elsewhere herein, the communication manager 140 may receive, from a first UE, an indication of whether a set of time-frequency resources, for communicating one or more signals between the second UE and the first UE, includes a gain control message; and receive, during the set of time-frequency resources, the one or more signals in accordance with whether the set of time-frequency resources includes the gain control message. Additionally or alternatively, the communication manager 140 may perform one or more other operations described herein.

In some aspects, the network node 110 may include a communication manager 150. As described in more detail elsewhere herein, the communication manager 150 may transmit, to at least one of a first UE or a second UE, an indication of a set of time-frequency resources for communicating one or more signals between the first UE and the second UE; and transmit, to the first UE, a gain control configuration associated with the set of time-frequency resources. Additionally or alternatively, the communication manager 150 may perform one or more other operations described herein.

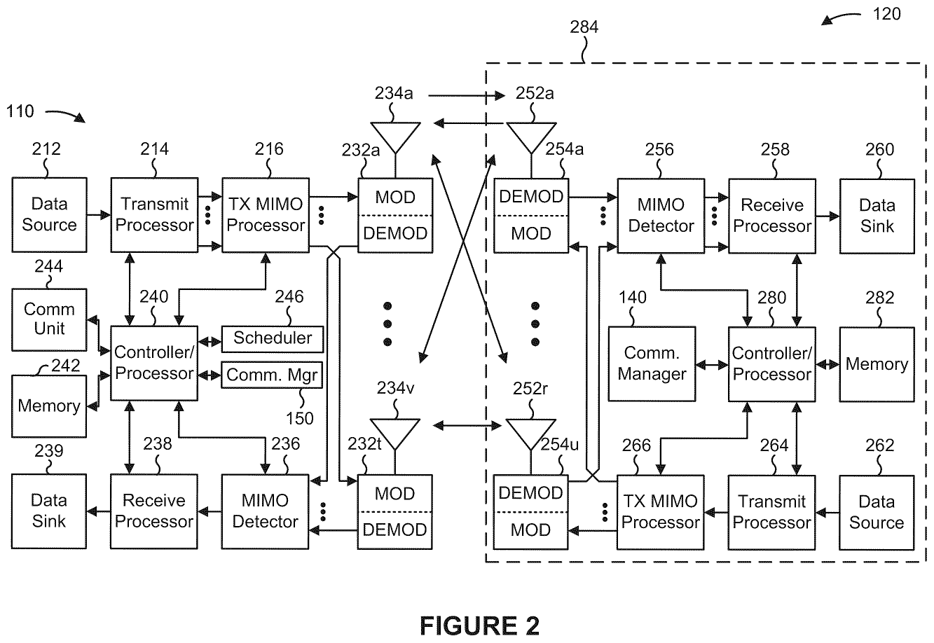

FIG. 2 is a diagram illustrating an example network node 110 in communication with an example UE 120 in a wireless communication network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal, and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different quantity of antenna elements. As another example, a network node 110 may include eight antenna elements, 24 antenna elements, 64 antenna elements, 128 antenna elements, or a different quantity of antenna elements. Generally, a larger quantity of antenna elements may provide increased control over parameters for beam generation relative to a smaller quantity of antenna elements, whereas a smaller quantity of antenna elements may be less complex to implement and may use less power than a larger quantity of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

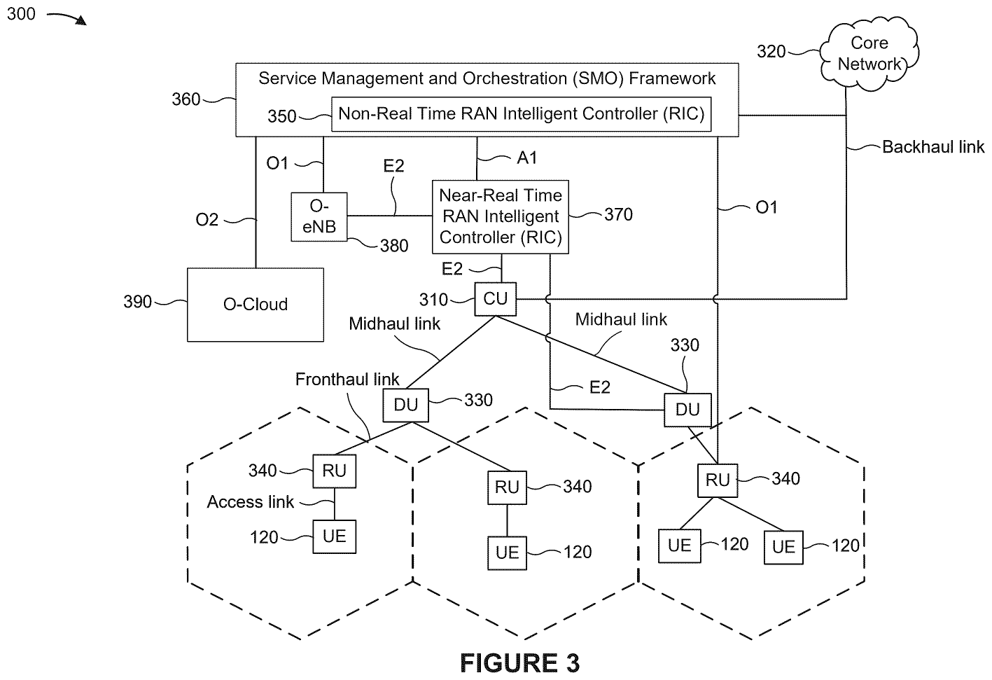

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

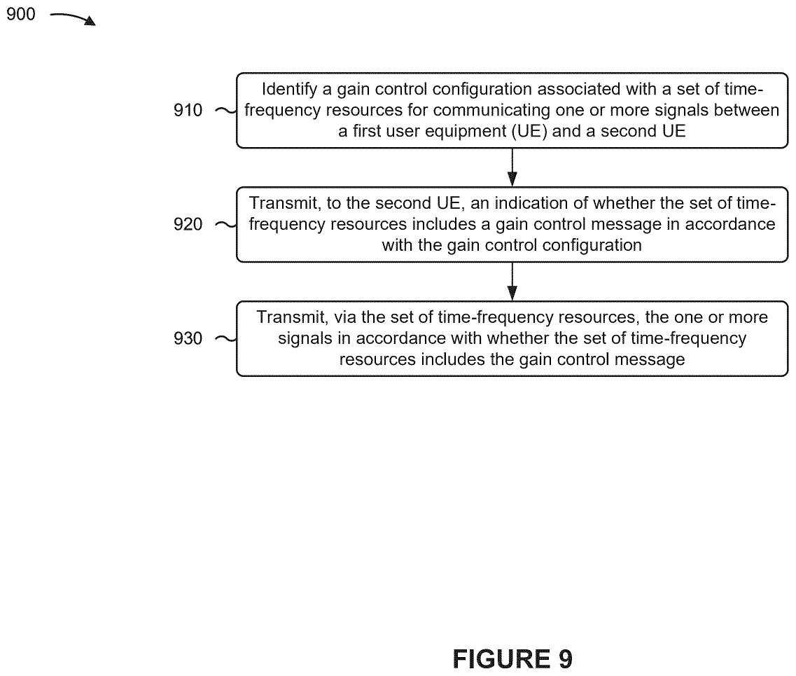

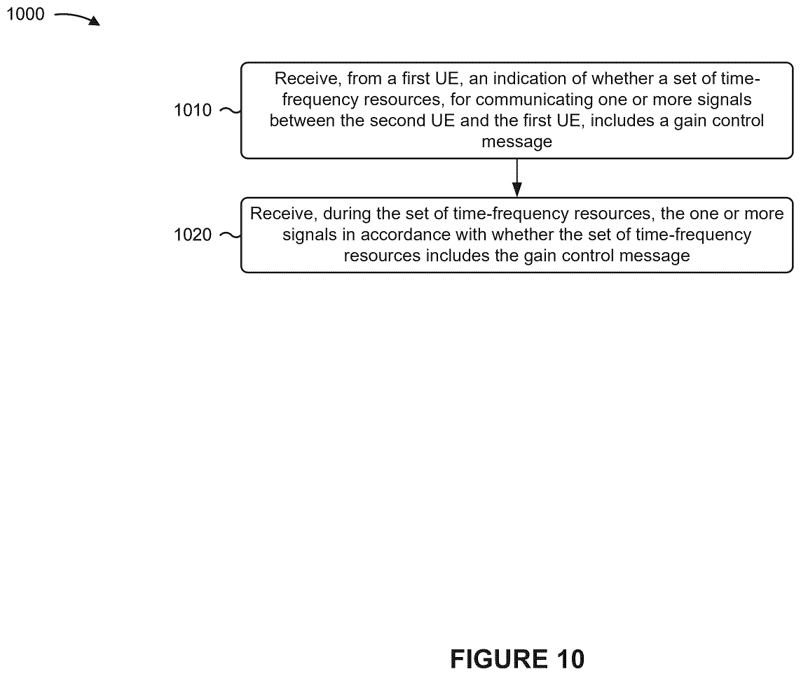

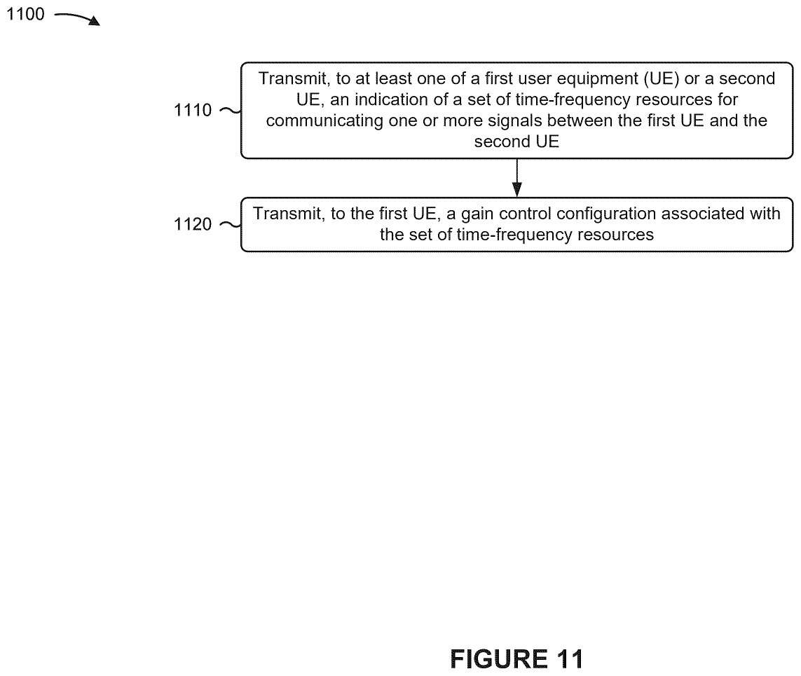

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with sidelink AGC, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, process 1100 of FIG. 11, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, process 1100 of FIG. 11, or other processes as described herein. In some examples, executing instructions may include running the instructions, converting the instructions, compiling the instructions, and/or interpreting the instructions, among other examples.

In some aspects, a first UE includes means for identifying a gain control configuration associated with a set of time-frequency resources for communicating one or more signals between the first UE and a second UE; means for transmitting, to the second UE, an indication of whether the set of time-frequency resources includes a gain control message in accordance with the gain control configuration; and/or means for transmitting, via the set of time-frequency resources, the one or more signals in accordance with whether the set of time-frequency resources includes the gain control message. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a second UE includes means for receiving, from a first UE, an indication of whether a set of time-frequency resources, for communicating one or more signals between the second UE and the first UE, includes a gain control message; and/or means for receiving, during the set of time-frequency resources, the one or more signals in accordance with whether the set of time-frequency resources includes the gain control message. The means for the second UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node includes means for transmitting, to at least one of a first UE or a second UE, an indication of a set of time-frequency resources for communicating one or more signals between the first UE and the second UE; and/or means for transmitting, to the first UE, a gain control configuration associated with the set of time-frequency resources. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

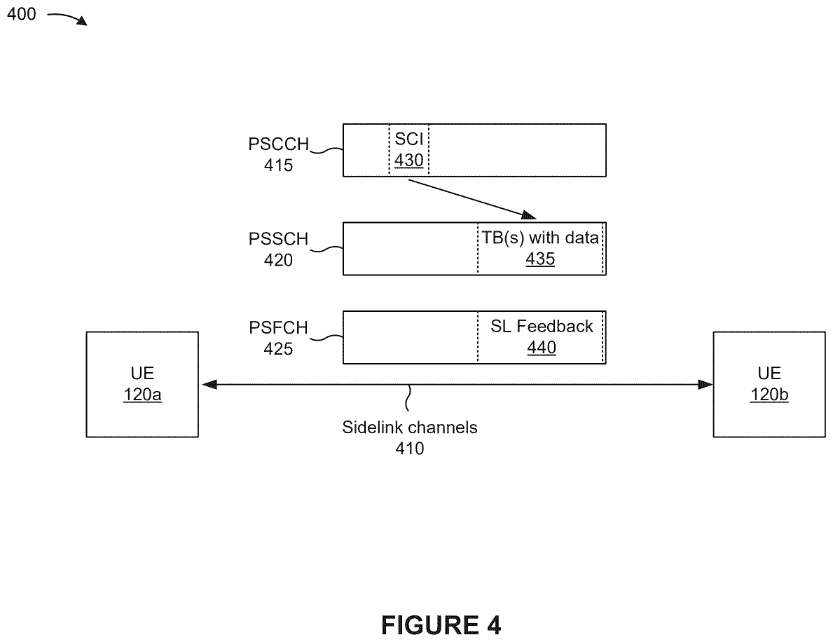

FIG. 4 is a diagram illustrating an example 400 of sidelink communications in accordance with the present disclosure.

As shown in FIG. 4, a first UE 120a may communicate with a second UE 120b (and one or more other UEs 120) via one or more sidelink channels 410. The UEs 120a and 120b may communicate using the one or more sidelink channels 410 for P2P communications, D2D communications, V2X communications (for example, which may include V2V communications, V2I communications, and/or V2P communications) and/or mesh networking. In some aspects, the UEs 120 (for example, UE 120a and/or UE 120b) may correspond to one or more other UEs described elsewhere herein, such as UE 120. In some aspects, the one or more sidelink channels 410 may use a PC5 interface and/or may operate in a high frequency band (for example, the 5.9 GHz band). Additionally or alternatively, the UEs 120 may synchronize timing of transmission time intervals (TTIs) (for example, frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a network node 110 via an access link or an access channel. The PSSCH 420 may be used to communicate data, similar to a physical downlink shared channel (PDSCH) and/or a physical uplink shared channel (PUSCH) used for cellular communications with a network node 110 via an access link or an access channel. For example, the PSCCH 415 may carry sidelink control information (SCI) 430, which may indicate various control information used for sidelink communications, such as one or more resources (for example, time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (for example, acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (for example, time resources, frequency resources, and/or spatial resources) on the PSSCH 420, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or an MCS. The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

In some aspects, the one or more sidelink channels 410 may use resource pools. For example, a scheduling assignment (for example, included in SCI 430) may be transmitted in sub-channels using specific resource blocks (RBs) across time. In some aspects, data transmissions (for example, on the PSSCH 420) associated with a scheduling assignment may occupy adjacent RBs in the same subframe as the scheduling assignment (for example, using frequency division multiplexing). In some aspects, a scheduling assignment and associated data transmissions are not transmitted on adjacent RBs.

In some aspects, a UE 120 may operate using a sidelink transmission mode (for example, Mode 1) where resource selection and/or scheduling is performed by a network node 110 (for example, a base station, a CU, or a DU). For example, the UE 120 may receive a grant (for example, in DCI or in a RRC message, such as for configured grants) from the network node 110 (for example, directly or via one or more network nodes) for sidelink channel access and/or scheduling. In some aspects, a UE 120 may operate using a transmission mode (for example, Mode 2) where resource selection and/or scheduling is performed by the UE 120 (for example, rather than a network node 110). In some aspects, the UE 120 may perform resource selection and/or scheduling by sensing channel availability for transmissions. For example, the UE 120 may measure a received signal strength indicator (RSSI) parameter (for example, a sidelink-RSSI (S-RSSI) parameter) associated with various sidelink channels, may measure an RSRP parameter (for example, a PSSCH-RSRP parameter) associated with various sidelink channels, and/or may measure a reference signal received quality (RSRQ) parameter (for example, a PSSCH-RSRQ parameter) associated with various sidelink channels, and may select a channel for transmission of a sidelink communication based at least in part on the measurement(s).

Additionally or alternatively, the UE 120 may perform resource selection and/or scheduling using SCI 430 received in the PSCCH 415, which may indicate occupied resources and/or channel parameters. Additionally or alternatively, the UE 120 may perform resource selection and/or scheduling by determining a channel busy ratio (CBR) associated with various sidelink channels, which may be used for rate control (for example, by indicating a maximum quantity of resource blocks that the UE 120 can use for a particular set of subframes).

In the transmission mode where resource selection and/or scheduling is performed by a UE 120, the UE 120 may generate sidelink grants, and may transmit the grants in SCI 430. A sidelink grant may indicate, for example, one or more parameters (for example, transmission parameters) to be used for an upcoming sidelink transmission, such as one or more resource blocks to be used for the upcoming sidelink transmission on the PSSCH 420 (for example, for TBs 435), one or more subframes to be used for the upcoming sidelink transmission, and/or an MCS to be used for the upcoming sidelink transmission. In some aspects, a UE 120 may generate a sidelink grant that indicates one or more parameters for semi-persistent scheduling (SPS), such as a periodicity of a sidelink transmission. Additionally or alternatively, the UE 120 may generate a sidelink grant for event-driven scheduling, such as for an on-demand sidelink message.

Communications between the UE 120a and the UE 120b may be affected by fluctuations in received signal power at a receiving UE 120 due to a location of the UE 120 relative to the UE 120b and/or a mobility of the UE 120a and/or the UE 120b. Received signal power variations may cause a degradation in the quality and/or reliability of communications between the UE 120a and UE 120b. For example, variations in received power may cause a reduced signal-to-noise ratio (SNR) (for example, causing some signals to be harder to distinguish from noise), increased bit error rate, increased susceptibility to interference, connection drops, and/or higher power consumption to compensate for low receive power, among other examples. As a result, a portion of each sidelink resource for transmitting the PSCCH, the PSSCH, and/or the PSFCH may be reserved for an AGC message used to perform AGC training.

As indicated above, FIG. 4 is provided as an example. Other examples may differ from what is described with respect to FIG. 4.

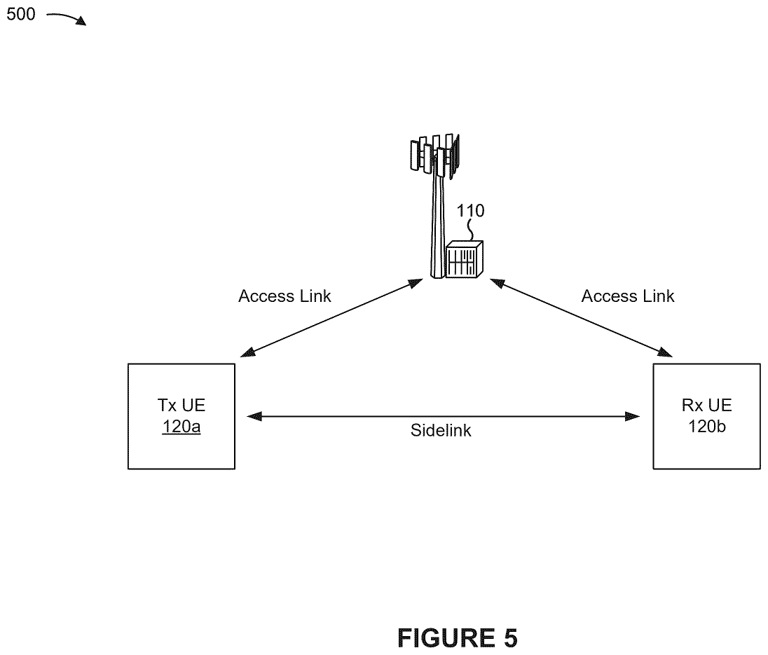

FIG. 5 is a diagram illustrating an example 500 of sidelink communications and access link communications in accordance with the present disclosure.

As shown in FIG. 5, a Tx UE 120a and an Rx UE 120b may communicate with one another via a sidelink, as described above in connection with FIG. 4. As further shown, in some sidelink modes, a network node 110 may communicate with the Tx UE 120a (for example, directly or via one or more network nodes), such as via a first access link. Additionally or alternatively, in some sidelink modes, the network node 110 may communicate with the Rx UE 120b (for example, directly or via one or more network nodes), such as via a first access link. The Tx UE 120a and/or the Rx UE 120b may correspond to one or more UEs described elsewhere herein, such as the UE 120 of FIG. 1. Thus, a direct link between UEs 120 (for example, via a PC5 interface) may be referred to as a sidelink, and a direct link between a network 110 and a UE 120 (for example, via a Uu interface) may be referred to as an access link. Sidelink communications may be transmitted via the sidelink, and access link communications may be transmitted via the access link. An access link communication may be either a downlink communication (from a network node 110 to a UE 120) or an uplink communication (from a UE 120 to a network node 110).

In some systems, AGC may be implemented to address the issue of varying signal characteristics in sidelink communications. For example, Rx UE 120b may perform AGC for reception of a sidelink communication transmitted by Tx UE 120a. In one example, the Rx UE 120b may regulate a received signal strength of the sidelink communication by performing outer loop AGC on the sidelink communication after an RF chain of the Rx UE 120b and prior to the sidelink communication being provided to an analog-to-digital converter (ADC) for analog-to-digital conversion. The outer loop AGC may include a closed feedback loop that measures a signal strength of the sidelink communication after analog-to-digital conversion, and modifies the RF gain parameter based at least in part on the measurement. If the signal strength is weak (for example, is below a low threshold), then the outer loop AGC may modify the RF gain parameter to boost one or more receiver gain stages in the RF chain to reduce noise and improve the SNR of the sidelink communication. Conversely, if the signal strength of the sidelink communication is strong (for example, is above a high threshold), then the outer loop AGC may modify the RF gain parameter to attenuate the one or more receiver gain stages in the RF chain to reduce signal clipping and/or nonlinear degradations of the sidelink communication.

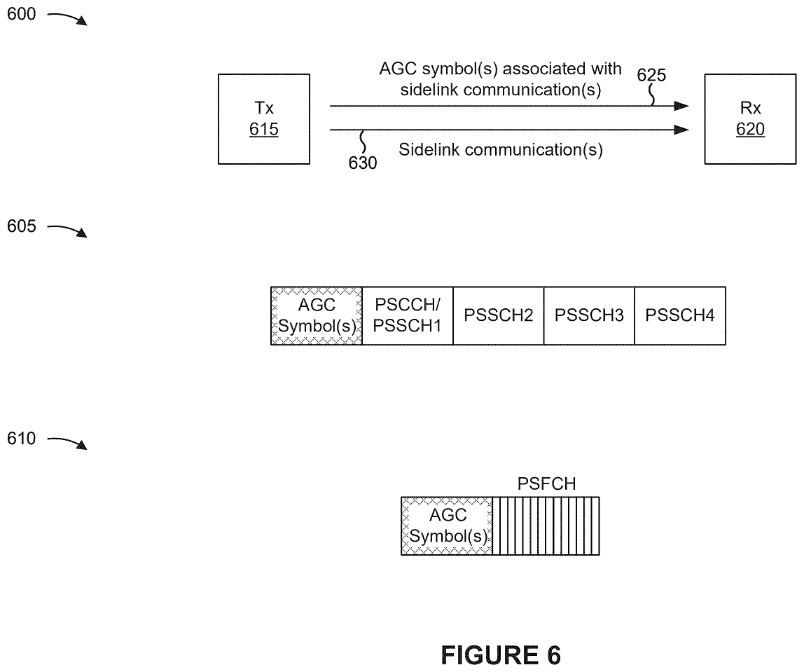

FIG. 6 is a diagram illustrating examples associated with AGC training for sidelink communications in accordance with the present disclosure. An example 600 includes communication between a transmitter wireless communication device (Tx) 615 and a receiver wireless communication device (Rx) 620. In some aspects, the transmitter wireless communication device 615 and the receiver wireless communication device 620 may be included in a wireless network, such as a wireless network 100. In some aspects, the transmitter wireless communication device 615 may correspond to a UE 120, a UE 120a, a Tx UE 120a, or another wireless communication device described herein. In some aspects, the receiver wireless communication device 620 may correspond to a UE 120, a UE 120b, an Rx UE 120b, or another wireless communication device described herein. The transmitter wireless communication device 615 and the receiver wireless communication device 620 may communicate via a sidelink (for example, via a PC5 interface).

The transmitter wireless communication device 615 may transmit, and the receiver wireless communication device 620 may receive, one or more AGC symbols 625 associated with one or more sidelink communications. In some examples, the one or more AGC symbols may include a group of symbols for use in performing AGC for the one or more sidelink communications. That is, the one or more AGC symbols includes multiple symbols that, upon receipt by the receiver wireless communication device 620, can be used to perform AGC for reception of one or more sidelink communications to be transmitted by the transmitter wireless communication device 615 for reception by the receiver wireless communication device 620.

In some aspects, an SCS of the one or more AGC symbols and an SCS of symbols of the one or more sidelink communications are at least 120 kHz. That is, the one or more AGC symbols and of symbols of the one or more sidelink communications may have a relatively high SCS. In some aspects, the one or more AGC symbols and the symbols of the one or more sidelink communications may be transmitted in a high frequency band, such as an FR2 frequency band (for example, a frequency band in FR2-2).

In some aspects, the one or more AGC symbols includes one or more repetitions of a symbol of the one or more sidelink communications. That is, the one or more AGC symbols may include N (N>1) symbols, where each of the N symbols is a repetition of a particular symbol of the following one or more sidelink communications. In some aspects, the symbol of the one or more sidelink communications that is used as the N AGC symbols may be a first (for example, first in the time-domain) symbol of the one or more sidelink communications. As one illustrative example, the one or more AGC symbols may include four symbols, where a first (in-time) AGC symbol is a repetition first (in-time) symbol of a sidelink communication, a second (in-time) AGC symbol is a repetition the first symbol of the sidelink communication, a third (in-time) AGC symbol is a repetition the first symbol of the sidelink communication, and a fourth (in-time) AGC symbol is a repetition the first symbol of the sidelink communication. In some aspects, repetition of the symbol (for example, the first symbol) of the one or more sidelink communications prevents an increase in complexity and resource consumption (for example, battery power, processor resources) in association with transmitting the one or more AGC symbols. For example, because the one or more AGC symbols include repetitions of a symbol that already needs to be generated by the transmitter wireless communication device 615, the transmitter wireless communication device 615 does need not to generate any symbols in addition to the symbols of the one or more sidelink communications. Therefore, complexity and resource consumption at the transmitter wireless communication device 615 are not increased.

In some aspects, the one or more AGC symbols includes a repetition of a plurality of symbols of the one or more sidelink communications, where each AGC symbol of the one or more AGC symbols corresponds to a respective symbol from the plurality of symbols of the one or more sidelink communications. That is, the one or more AGC symbols may include N symbols, with the N symbols being a repetition of a particular group of N symbols of the following one or more sidelink communications. In some aspects, the N symbols of the one or more sidelink communications that are used as the N AGC symbols may be a first (for example, first in the time-domain) N symbols of the one or more sidelink communications. As one illustrative example, the one or more AGC symbols may include four symbols, where a first (in-time) AGC symbol is a repetition first (in-time) symbol of a sidelink communication, a second (in-time) AGC symbol is a repetition second (in-time) symbol of the sidelink communication, a third (in-time) AGC symbol is a repetition third (in-time) symbol of the sidelink communication, and a fourth (in-time) AGC symbol is a repetition fourth (in-time) symbol of the sidelink communication. In some such aspects, if the quantity of symbols in the one or more AGC symbols is greater than the quantity of symbols in the one or more sidelink communications, then the one or more AGC symbols may include one or more repetitions of a symbol (for example, the first symbol) of the one or more sidelink communications. That is, if N is greater than the quantity of symbols in the one or more sidelink communications, then the one or more AGC symbols may include a repetition of each symbol of the one or more sidelink communications and one or more additional repetitions of a particular symbol of the one or more sidelink communications.

In some aspects, repetition of the plurality of symbols (for example, the first N symbols) of the one or more sidelink communications prevents an increase in complexity and resource consumption (for example, battery power, processor resources) in association with transmitting the one or more AGC symbols. For example, because the one or more AGC symbols includes repetitions of symbols that already need to be generated by the transmitter wireless communication device 615, the transmitter wireless communication device 615 does need not to generate any symbols in addition to the symbols of the one or more sidelink communications. Therefore, complexity and resource consumption at the transmitter wireless communication device 615 are not increased.

In some aspects, the transmitter wireless communication device 615 may generate the one or more AGC symbols. For example, in some aspects, the transmitter wireless communication device 615 may generate the one or more AGC symbols based at least in part on a quadrature phase shift keying (QPSK) sequence. That is, the transmitter wireless communication device 615 may (randomly) generate a QPSK sequence, apply an inverse FFT and a cyclic prefix (CP), and use a result as the one or more AGC symbols. As another example, the transmitter wireless communication device 615 may generate the one or more AGC symbols based at least in part on a quadrature amplitude modulation (QAM) sequence. That is, the transmitter wireless communication device 615 may (randomly) generate a QAM sequence with a modulation order that matches a modulation order of the one or more sidelink communications, and may use a result as the one or more AGC symbols. In some aspects, the transmitter wireless communication device 615 may generate the one or more AGC symbols based at least in part on one or more parameters (for example, a precoding parameter, a beamforming parameter, or the like) that match a corresponding one or more parameters applied in association with generating symbols of the one or more sidelink communications. In some aspects, the use of a plurality of randomly generated symbols enables transmission of the one or more AGC symbols irrespective of timing of generation of symbols of the one or more sidelink communications. That is, because the one or more AGC symbols does not depend on symbols of the one or more sidelink communications when randomly generated symbols are used, the symbols of the one or more sidelink communications need not be ready for transmission at the time of transmission of the one or more AGC symbols. Thus, late-arriving packets associated with the one or more sidelink communications do not impact transmission of the one or more AGC symbols.

In some aspects, the one or more AGC symbols includes a repetition of a DMRS associated with the one or more sidelink communications. That is, in some aspects, the transmitter wireless communication device 615 may use the DMRS of the one or more sidelink communications as the one or more AGC symbols. As one example, for a PUCCH format 0 (PF0) PSFCH communication, the transmitter wireless communication device 615 may use a length-12 computer generated sequence in the PSFCH as the one or more AGC symbols. As another example, for a PSCCH communication or a PSSCH communication, the transmitter wireless communication device 615 may repeat a DMRS and copy the DMRS to the AGC symbols. In some aspects, the use of the DMRS enables transmission of the one or more AGC symbols irrespective of timing of generation of symbols of the one or more sidelink communications. That is, because the one or more AGC symbols does not depend on symbols of the one or more sidelink communications when the DMRS is used as the one or more AGC symbols, the symbols of the one or more sidelink communications need not be ready at the time of transmission of the one or more AGC symbols. Thus, late-arriving packets associated with the one or more sidelink communications do not impact transmission of the one or more AGC symbols.

After transmitting the one or more AGC symbols, the transmitter wireless communication device 615 may transmit, and the receiver wireless communication device 620 may receive, the one or more sidelink communications 630.

In some aspects, the one or more sidelink communications may include one or more PSCCH communications or one or more PSSCH communications. In some such aspects, the one or more PSCCH communications or the one or more PSSCH communications are transmitted in a plurality of contiguous slots (sometimes referred to as a super-slot) and the one or more AGC symbols are transmitted in one or more slots immediately prior to the plurality of contiguous slots.

An example 605 includes transmission of one or more AGC symbols immediately prior to a plurality of contiguous slots. In the example 605, the one or more AGC symbols comprises a slot of AGC symbols (for example, 14 AGC symbols). As shown, the AGC slot is transmitted immediately prior to a plurality of contiguous slots in which a PSCCH communication and four PSSCH communications are transmitted. In some aspects, the plurality of contiguous slots is associated with a single receiver wireless communication device 620. In such an aspect, the receiver wireless communication device 620 can perform AGC training at a start of the plurality of contiguous slots only (for example, rather than prior to each slot), and a result of the AGC training can be applied to reception of a sidelink communication in each of the plurality of contiguous slots. Here, because transmission in the high frequency range of operation (for example, FR2-2) is directional, a likelihood that the receiver wireless communication device 620 receives other sidelink communications during the plurality of contiguous slots with the same receive beam is negligible.

Additionally or alternatively, the one or more one or more sidelink communications include one or more PSFCH communications. In some such aspects, the one or more PSFCH communications are transmitted in a single slot and the one or more AGC symbols are transmitted in one or more slots immediately prior to the single slot. FIG. 6 includes an example 610 of a transmission of one or more AGC symbols immediately prior to a slot including multiple PSFCH communications.

In the example 610, the one or more AGC symbols includes a slot of AGC symbols (for example, 14 AGC symbols). As shown, the AGC slot is transmitted immediately prior to a slot in which a plurality of PSFCH communications are transmitted. In this way, multiple PSFCH symbols (for example, each mapped to a different PSSCH slot) can be grouped into a single slot and can share the one or more AGC symbols.

In an aspect in which the one or more AGC symbols is transmitted prior to a plurality of sidelink communications (for example, a super-slot of PSCCH/PSSCH communications, a single slot of multiple PSFCH communications), the one or more AGC symbols can be utilized in association with performing AGC for each of the one or more sidelink communications. In this way, AGC overhead is reduced, thereby increasing throughput for sidelink communications.

However, performing AGC for each of the one or more sidelink communications may inefficiently consume resources. For example, the AGC procedure may include communicating an AGC message via one or more AGC resources with each communication from transmitting devices. In such examples, the receiver wireless communication device 620 and/or the transmitter wireless communication device 615 may dedicate at least a portion of each respective resource set to the AGC procedure even when receive power variations are insignificant. For example, there may be scenarios where performing an AGC procedure, (and thus dedicating resources for the AGC procedure) may be superfluous. For example, when a power variation between two resource sets (for example, slots) is (or expected to be) small and/or insignificant (for example, within a dynamic range, or unlikely to cause a noticeable degradation in communication quality), performing the AGC procedure may be an inefficient use of resources. A power variation between two resources may be expected to be small and/or insignificant when transmissions spanning multiple resource sets are from a single transmitting device, are not frequency division multiplexed with other transmitting devices, are grouped together by devices such that communications from a transmitting device are communicated via subsequent resource sets, and/or are grouped together by device location such that communications from similarly located transmitting devices are communicated via subsequent resource sets. As a result, the default performance of an AGC procedure by the receiver wireless communication device 620 and/or the transmitter wireless communication device 615 may consume resources without providing a significant benefit to the quality of sidelink communications, especially in examples where receive power variations are insignificant or are expected to be insignificant.

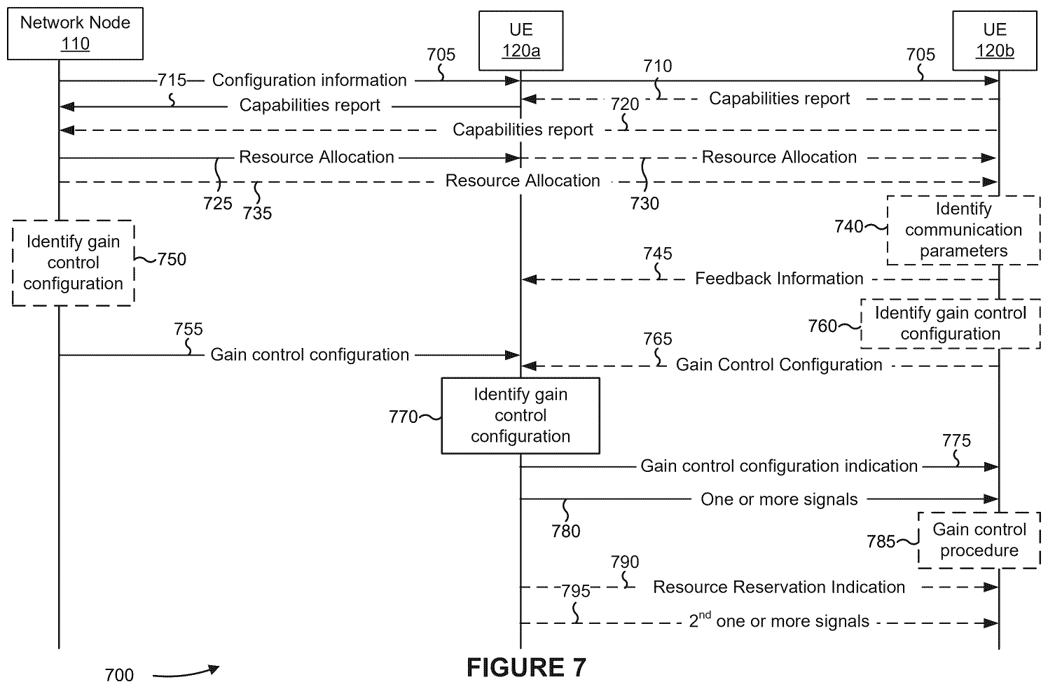

FIG. 7 is a diagram of an example 700 associated with sidelink gain control in accordance with the present disclosure. As shown in FIG. 7, a network node 110 (for example, network node 110, a CU, a DU, and/or an RU) may communicate with a first UE (for example, UE 120), which may be referred to as a Tx UE 120a in reference to the role of the Tx UE 120a in the communication of a gain control resource; however, the Tx UE 120a may be capable of transmitting and receiving communications with the network node 110 and/or a second UE (for example, UE 120). The network node 110 and/or the Tx UE 120a may communicate with the second UE, which may be referred to as an Rx UE 120b in reference to the role of the Rx UE 120b in the communication of a gain control resource; however, the Rx UE 120b may be capable of transmitting and receiving communications with the network node 110 and/or the Tx UE 120a. In some aspects, the network node 110, the Tx UE 120a, and the Rx UE 120b may be part of a wireless network (for example, wireless network 100). The Tx UE 120a and the Rx UE 120b, the Tx UE 120a and the network node 110, and/or the network node 110 and the Rx UE 120b may have established a wireless connection prior to operations shown in FIG. 7.

The example 700 depicts an example process for a configurable gain control symbol in which a gain control configuration (for example, identified and/or communicated by any of the Rx UE 120b, Tx UE 120a, and/or network node 110) indicates whether a gain control procedure is to be applied to a set of time-frequency resources for communicating one or more signals between the Tx UE 120a and the Rx UE 120b. For example, each set of time-frequency resources scheduled for communications between the Tx UE 120a and the Rx UE 120b may include a time-frequency resource for communicating the gain control message. The time-frequency resource for communicating the gain control message may be reserved for a gain control message but, in accordance with the example 700, may be configurable in that the time-frequency resource for communicating the gain control message may be used for other communications when the network node 110, the Tx UE 120a, and/or the Rx UE 120b determine that a gain control procedure (for example, AGC training) may be skipped and/or that receive power levels at the Rx UE 120b are (or are expected to be) relatively stable. In such examples, an inclusion of the gain control message in the set of time-frequency resources may enable the gain control procedure for the one or more signals. Additionally or alternatively, an absence of the gain control message in the set of time-frequency resources may disable a gain control procedure for the one or more signals.

The example 700 may be an example of unicast communications between the Tx UE 120a and the Rx UE 120b in which configurable AGC is adopted for sidelink unicast communications by relevant telecommunications standards. Additionally or alternatively, the example 700 may be an example of unicast communications between the Tx UE 120a and the Rx UE 120b in which configurable AGC is optional, and signaling from the network node 110 may enable and/or disable configurable AGC.

In a first operation 705, the network node 110 may transmit, and the Tx UE 120a may receive, configuration information. In some aspects, the Tx UE 120a may receive the configuration information via one or more of system information (for example, a master information block (MIB) and/or a system information block (SIB), among other examples), RRC signaling, one or more medium MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. For example, the subsequent indication may select a candidate configuration and/or communication parameter from the one or more candidate configurations and/or communication parameters. In some aspects, the subsequent indication (for example, an indication described herein) may include a dynamic indication, such as one or more MAC CEs and/or one or more DCI messages, among other examples.

In some aspects, the configuration information may indicate that the Tx UE 120a and/or the Rx UE 120b is to enable and/or disable a gain control procedure.

The Tx UE 120a may configure itself based at least in part on the configuration information. In some aspects, the Tx UE 120a may be configured to perform one or more operations described herein based at least in part on the configuration information.

In a second operation 710, the Rx UE 120b may transmit, and the Tx UE 120a may receive, a capabilities report. The capabilities report may indicate whether the Rx UE 120b supports a feature and/or one or more parameters related to the feature. For example, the capability information may indicate a capability and/or parameter for enabling/disabling a configurable gain control resource. As another example, the capabilities report may indicate a capability and/or parameter for identifying a gain control procedure. For example, the Rx UE 120b may transmit, and the Tx UE 120a may receive, a capability message (for example, as part of the capabilities report) indicating a capability of the Rx UE 120b for identifying a gain control configuration. In some aspects, the Rx UE 120b may transmit, and the Tx UE 120a may receive, a capability message indicating a capability of the Rx UE 120b for receiving the one or more signals in accordance with whether the set of time-frequency resources includes the gain control message.

In a third operation 715, the Tx UE 120a may transmit, and the network node 110 may receive, a capabilities report. The capabilities report may indicate whether the Tx UE 120a supports a feature and/or one or more parameters related to the feature. For example, the capability information may indicate a capability and/or parameter for enabling/disabling a configurable gain control resource. As another example, the capabilities report may indicate a capability and/or parameter for identifying a gain control procedure. For example, the Tx UE 120a may transmit, and the network node 110 may receive, a capability message (for example, as part of the capabilities report) indicating a capability of the Tx UE 120a for identifying a gain control configuration. In some examples, the capabilities report described as part of the third operation 715 may indicate one or more capabilities of the Rx UE 120b described as part of the second operation 710.

Additionally or alternatively, in a fourth operation 720, the Rx UE 120b may transmit, and the network node 110 may receive, the capabilities report. The capabilities report may indicate whether the Rx UE 120b supports a feature and/or one or more parameters related to the feature. For example, the capability information may indicate a capability and/or parameter for enabling/disabling a configurable gain control resource. As another example, the capabilities report may indicate a capability and/or parameter for identifying a gain control procedure. For example, the Rx UE 120b may transmit, and the network node 110 may receive, a capability message (for example, as part of the capabilities report) indicating a capability of the Rx UE 120b for identifying a gain control configuration. In some aspects, the Rx UE 120b may transmit, and the network node 110 may receive, a capability message indicating a capability of the Rx UE 120b for receiving the one or more signals in accordance with whether the set of time-frequency resources includes the gain control message.

One or more operations described herein may be based on or otherwise associated with capability information of the capabilities report. For example, the Tx UE 120a and/or the Rx UE 120b may perform a communication in accordance with the capability information, or may receive configuration information that is in accordance with the capability information. In some aspects, the capabilities report may indicate UE support for configurable sidelink AGC.

In some aspects, the configuration information described as part of the first operation 705 and/or the capabilities report(s) described as part of the operations 710, 715, and/or 720 may include information transmitted via multiple communications. Additionally or alternatively, the network node 110 may transmit the configuration information, or a communication including at least a portion of the configuration information, before and/or after the Tx UE 120a and/or the Rx UE 120b transmits the capabilities report(s). For example, the network node 110 may transmit a first portion of the configuration information before the capabilities report, the Tx UE 120a and/or the Rx UE 120b may transmit at least a portion of the capabilities report(s), and the network node 110 may transmit a second portion of the configuration information after receiving the capabilities report.

In a fifth operation 725, the network node 110 may transmit, and the Tx UE 120a may receive, a resource allocation. For example, the network node 110 may transmit, and the Tx UE 120a may receive, an indication of a plurality of time-frequency resource sets for communications between the Tx UE 120a and the Rx UE 120b.

In a sixth operation 730, the Tx UE 120a may transmit and/or relay from the network node 110, and the Rx UE 120b may receive, a resource allocation. For example, the Tx UE 120a may transmit, and the Rx UE 120b may receive, an indication of a plurality of time-frequency resource sets for communications between the Tx UE 120a and the Rx UE 120b.

In a seventh operation 735, the network node 110 may transmit, and the Rx UE 120b may receive, a resource allocation. For example, the network node 110 may transmit, and the Rx UE 120b may receive, an indication of a plurality of time-frequency resource sets for communications between the Tx UE 120a and the Rx UE 120b. In some aspects, the resource allocation described as part of the operations 725, 730, and/or 735 may include a configured grant including the indication of the plurality of time-frequency resource sets.

In an eighth operation 740, the Rx UE 120b may identify one or more communication parameters. For example, the Rx UE 120b may identify one or more parameters associated with communications between the Tx UE 120a and the Rx UE 120b. In some aspects, the one or more parameters may include an MCS associated with the one or more signals, a channel quality index, an SNR, an RSRP, a quality-of-service associated with the one or more signals, a delay spread, a received signal strength, a decoding performance parameter, and/or a reference signal received quality.

In a ninth operation 745, the Rx UE 120b may transmit, and the Tx UE 120a may receive, feedback information. For example, the Rx UE 120b may transmit, and the Tx UE 120a may receive, feedback information associated with communications between the Tx UE 120a and the Rx UE 120b. The feedback information may include a channel quality index, an SNR, an RSRP, a delay spread, a received signal strength, a decoding performance parameter, and/or a reference signal received quality, among other examples. In some aspects, the feedback information may indicate whether performing a gain control procedure would be beneficial for communications between the Tx UE 120a and the Rx UE 120b.

In a tenth operation 750, the network node 110 may identify a gain control configuration. For example, the network node 110 may identify the gain control configuration in accordance with one or more parameters associated with communications between the Tx UE 120a and the Rx UE 120b. In some aspects, the one or more parameters may include a quantity of UEs scheduled for communications with the Rx UE 120b, a multiplexing scheme associated with the communications between the Tx UE 120a and the Rx UE 120b, and/or a transmission type associated with the one or more signals.

In an eleventh operation 755, the network node 110 may transmit, and the Tx UE 120a may receive, a gain control configuration. For example, the network node 110 may transmit, and the Tx UE 120a may receive, an indication of the gain control configuration. In some aspects, transmitting and/or receiving the indication of the gain control configuration described as part of the eleventh operation 755 includes transmitting and/or receiving the indication of the gain control configuration via a DCI message and/or an SCI message. In some aspects, the gain control configuration is communicated between the network node 110 and the Tx UE 120a along with or otherwise as part of communicating the configuration information described as part of the first operation 705. In some aspects, communicating the gain control configuration described as part of the eleventh operation 755 is based on or otherwise in association with identifying the gain control configuration described as part of the tenth operation 750.

In a twelfth operation 760, the Rx UE 120b may identify a gain control configuration. For example, the Rx UE 120b may identify a gain control configuration associated with the set of time-frequency resources (for example, granted by the network node 110 as described as part of any of the operations 725, 730, and/or 735) for communicating the one or more signals between the Tx UE 120a and the Rx UE 120b. In some aspects, the gain control configuration may enable and/or disable a gain control procedure for the set of time-frequency resources. In some aspects, the gain control configuration may indicate whether the set of time-frequency resources includes, and/or whether additional sets of time-frequency resources include, a gain control message. In some aspects, the gain control configuration may indicate a quantity of resources for performing the gain control procedure. In some aspects, identifying the gain control configuration described as part of the twelfth operation 760 may be based on or otherwise in association with identifying the one or more parameters described as part of the eight operation 740.

In a thirteenth operation 765, the Rx UE 120b may transmit, and the Tx UE 120a may receive, the gain control configuration. For example, the Rx UE 120b may transmit, and the Tx UE 120a may receive, an indication of the gain control configuration. In some aspects, transmitting the indication of the gain control configuration includes transmitting the indication of the gain control configuration via an SCI message. In some aspects, the gain control configuration indication may indicate a quantity of resources for communicating the gain control message. In such aspects, the quantity of symbols for performing a gain control procedure may be configurable. For example, the Rx UE 120b may transmit, and the Tx UE 120a may receive, an indication of a quantity of time-frequency resources, of the set of time-frequency resources, for communicating the gain control message. Additionally or alternatively, the Rx UE 120b may transmit, and the Tx UE 120a may receive, an indication of a portion of a time-frequency resource, of the set of time-frequency resources, for communicating the gain control message.

In a fourteenth operation 770, the Tx UE 120a may identify a gain control configuration. For example, the Tx UE 120a may identify a gain control configuration associated with the set of time-frequency resources (for example, granted by the network node 110 as described as part of any of the operations 725, 730, and/or 735) for communicating the one or more signals between the Tx UE 120a and the Rx UE 120b. In some aspects, the gain control configuration may enable and/or disable a gain control procedure for the set of time-frequency resources. In some aspects, the gain control configuration may indicate whether the set time-frequency resources includes, and/or whether additional sets of time-frequency resources include, a gain control message. In some aspects, the gain control configuration may indicate a quantity of resources for performing the gain control procedure.

In some aspects, identifying the gain control configuration described as part of the fourteenth operation 770 may be based on, or otherwise associated with, receiving, from the network node 110, the gain control configuration described as part of the eleventh operation 755. For example, the Tx UE 120a may receive the gain control configuration from the network node 110, and the Tx UE 120a may determine and/or identify whether the set of time-frequency resources includes a gain control message. In some aspects, the Tx UE 120a may determine and/or identify whether the set of time-frequency resources includes a gain control message based on or otherwise associated with an explicit indication in the gain control configuration or based on or otherwise associated with other information included in the gain control configuration, such as channel quality information, quality of service information, and/or scheduling information, among other examples.

In some aspects, identifying the gain control configuration described as part of the fourteenth operation 770 may be based on, or otherwise associated with, receiving, from the Rx UE 120b, the feedback information described as part of the ninth operation 745. For example, the Tx UE 120a may receive the feedback information from the Rx UE 120b, and the Tx UE 120a may determine and/or identify whether the set of time-frequency resources includes a gain control message in accordance with the feedback information. In some aspects, identifying the gain control configuration described as part of the fourteenth operation 770 may be based on, or otherwise associated with, one or more parameters associated with communications between the Tx UE 120a and the Rx UE 120b. In some aspects, the one or more parameters may include feedback from the Rx UE 120b, and/or may include parameters measured and/or observed by the Tx UE 120a. In some aspects, the parameters may include an MCS associated with the one or more signals, a channel quality index, an SNR, an RSRP, a quality-of-service associated with the one or more signals, a delay spread, a received signal strength, a decoding performance parameter, and/or a reference signal received quality.

In some aspects, identifying the gain control configuration described as part of the fourteenth operation 770 may include overriding the gain control configuration described as part of the eleventh operation 755. The Tx UE 120a may be configured and/or enabled to override a gain control configuration determined and/or communicated by the network node 110. For example, the Tx UE 120a may enable an AGC symbol in its transmission (for example, based on or otherwise associated with sidelink channel conditions, based on or otherwise associated with feedback and/or other information received from the Rx UE 120b, based on or otherwise associated with autonomous resource scheduling, among other examples) even in examples where the network node 110 has disabled the gain control symbol (for example, transmitted a gain control configuration indicating that the set of time-frequency resources excludes a gain control message). For example, as part of the eleventh operation 755, the network node 110 may transmit, and the Tx UE 120a may receive, an indication of a first gain control configuration, where the gain control configuration (for example, described as part of the fourteenth operation 770) includes a second gain control configuration that is different from the first gain control configuration.

In some aspects, the gain control configuration may indicate whether a gain control procedure is to be applied to each set of time-frequency resources of the plurality of time-frequency resource sets described as part of the fifth operation 725. In some aspects, the gain control configuration includes a bitmap (for example, communicated by the network node 110, the Tx UE 120a, and/or the Rx UE 120b). For example, the bitmap may indicate whether a gain control procedure is to be applied to each set of time-frequency resources of the plurality of time-frequency resource sets. In some aspects, the gain control configuration indicates that the gain control procedure is to be applied to a first set of time-frequency resources of the plurality of time-frequency resource sets (for example, described as part of the fifth operation 725), and indicates that a subsequent set of time-frequency resources of the plurality of time-frequency resource sets is to be communicated independently of the gain control procedure. For example, the time-frequency resource for the gain control symbol may be included in at least in some sidelink transmissions (for example, communicated via a set of time-frequency resources, a slot) and may be absent from others in accordance with the gain control configuration. In some aspects, a first occurring set of one or more signals from the Tx UE 120a to the Rx UE 120b may include a gain control message in accordance with the gain control configuration, while subsequent sets of one or more signals from the Tx UE 120a to the Rx UE 120b may not.

In a fifteenth operation 775, the Tx UE 120a may transmit, and the Rx UE 120b may receive, a gain control configuration indication. In some aspects, the gain control configuration indication may include an indication of whether the set of time-frequency resources includes a gain control message in accordance with the gain control configuration. For example, the Tx UE 120a may transmit, to the Rx UE 120b, the indication of whether the set of time-frequency resources includes a gain control message in accordance with the gain control configuration. In some aspects, the indication of whether the set of time-frequency resources includes the gain control message further indicates whether a subsequent set of time-frequency resources includes a second gain control message. For example, the Tx UE 120a may indicate (for example, via SCI) whether gain control is to be performed for communications during a subsequent set of time-frequency resources. In some aspects, communicating the gain control indication described as part of the fifteenth operation 775 is based on or otherwise in association with communicating the feedback information described as part of the ninth operation 745.

In some aspects, the gain control configuration indication may indicate a quantity of resources for communicating the gain control message. In such aspects, the quantity of symbols for performing a gain control procedure may be configurable. For example, the Tx UE 120a may transmit, and the Rx UE 120b may receive, an indication of a quantity of time-frequency resources, of the set of time-frequency resources, for communicating the gain control message. Additionally or alternatively, the Tx UE 120a may transmit, and the Rx UE 120b may receive, an indication of a portion of a time-frequency resource, of the set of time-frequency resources, for communicating the gain control message.

In some aspects, the Rx UE 120b may receive the indication of whether the set of time-frequency resources includes the gain control message described as part of the fifteenth operation 775 based on or otherwise in association with transmitting the indication of the gain control configuration described as part of the thirteenth operation 765.

In a sixteenth operation 780, the Tx UE 120a may transmit, and the Rx UE 120b may receive, one or more signals, for example, based on or otherwise associated with communicating the gain control configuration described as part of the fifteenth operation 775. For example, the Tx UE 120a may transmit, and the Rx UE 120b may receive, via the set of time-frequency resources (for example, granted by the network node 110 as described as part of any of the operations 725, 730, and/or 735), the one or more signals in accordance with whether the set of time-frequency resources includes the gain control message. In some aspects, the one or more signals may include the gain control message, an indication of whether a second set of resources includes the gain control message and/or a second gain control message, one or more sidelink control channel messages, one or more sidelink shared channel messages, sidelink control information, and/or sidelink reference signals.

In some aspects, transmitting the one or more signals in accordance with whether the set of time-frequency resources includes the gain control message described as part of the sixteenth operation 780 may include transmitting a data message and/or a control message via the time-frequency resource, of the set of time-frequency resources, associated with the gain control message. For example, a gain control symbol may be used for sidelink control channel messages (for example, PSCCH messages), sidelink shared channel messages (for example, PSSCH messages), sidelink control information (for example, SCI messages), and/or sidelink reference signals (for example, DMRS, CSI-RS). In such aspects, the Rx UE 120b may refrain from performing a gain control procedure for the one or more signals in accordance with receiving at least one of the data message or the control message via the time-frequency resource associated with the gain control message.

In some aspects, transmitting the one or more signals in accordance with whether the set of time-frequency resources includes the gain control message described as part of the sixteenth operation 780 may include transmitting the gain control message via the time-frequency resource, of the set of time-frequency resources, associated with the gain control message. For example, the gain control configuration may enable the gain control resource (for example, AGC symbol), and the Tx UE 120a may transmit a gain control message during the gain control resource.

In a seventeenth operation 785, the Rx UE 120b may perform a gain control procedure. For example, the Tx UE 120a may transmit, and the Rx UE 120b may receive, the gain control message via a first time-frequency resource (for example, an AGC resource) of the set of time-frequency resources described as part of the fifteenth operation 775. The Rx UE 120b may perform the gain control procedure for the one or more signals, for example, based on or otherwise in association with receiving the gain control message via the first time-frequency resource. In some aspects, performing the gain control procedure may include the Rx UE 120b measuring a power associated with the first time-frequency resource, training a power gain in association with measuring the power associated with the first time-frequency resource, and applying the power gain to each of the one or more signals.

In an eighteenth operation 790, the Tx UE 120a may transmit, and the Rx UE 120b may receive, a resource reservation indication. For example, the Tx UE 120a may transmit, and the Rx UE 120b may receive, an indication of a second set of time-frequency resources for communicating an additional one or more signals in accordance with transmitting the one or more signals. In some aspects, when the Tx UE 120a transmits one or more signals to the Rx UE 120b during a first set of time-frequency resources (for example, a first slot), the Tx UE 120a may indicate a set of time-frequency resources (for example, slot location) for communicating an additional one or more signals to the Rx UE 120b. In some aspects, the Tx UE 120a may transmit SCI including the resource reservation indication.

In a nineteenth operation 795, the Tx UE 120a may transmit, and the Rx UE 120b may receive, a second one or more signals. For example, the Tx UE 120a may transmit, and the Rx UE 120b may receive, second one or more signals, for example, based on, or otherwise associated with communicating the resource reservation indication described as part of the nineteenth operation 790.

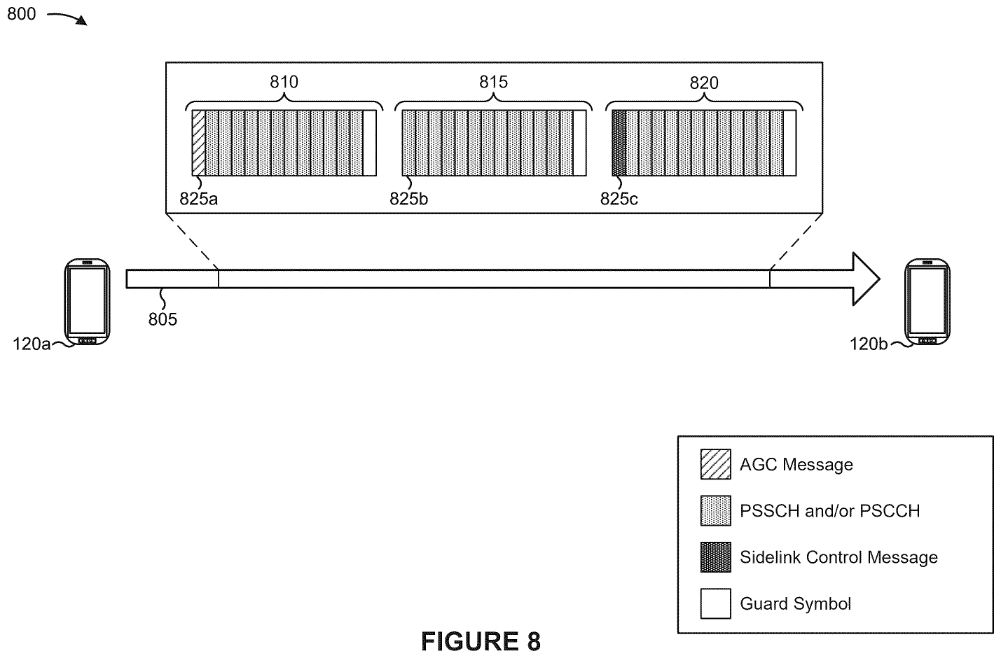

FIG. 8 is a diagram illustrating an example 800 of a configurable AGC resource in accordance with the present disclosure. As shown in FIG. 8, a Tx UE 120a and an Rx UE 120b may communicate with one another via sidelink 805.

The Tx UE 120a may transmit, and the Rx UE 120b may receive, a first set of resources 810, a second set of resources 815, and a third set of resources 820 via sidelink 805. Each set of resources may be an example of a set of symbols, a slot including a quantity of symbols, and/or another unit of time-frequency resource including a quantity of sub-resources.

Each set of resources may include a configurable AGC resource 825 (for example, a time-frequency resource associated with a gain control message). The first set of resources 810 may include a configurable AGC resource 825a that includes an AGC message. For example, the Rx UE 120b may receive the first set of resources 810 including the AGC message via the configurable AGC resource 825a, and may perform AGC training for the first set of resources 810 using the AGC message (for example, as described with reference to FIG. 6). The first set of resources 810 may further include one or more signals, such as one or more PSSCH messages and/or PSCCH messages. The first set of resources 810 may additionally include a guard symbol.

The second set of resources 815 may include a configurable AGC resource 825b that includes a PSSCH message and/or a PSCCH message. For example, the Rx UE 120b may receive the second set of resources 815 including a PSSCH message and/or a PSCCH message via the configurable AGC resource 825b and may refrain from performing AGC training using the AGC message. The Rx UE 120b may decode the configurable AGC symbol to receive the PSSCH message and/or a PSCCH message. The second set of resources 815 may further include one or more signals, such as one or more additional PSSCH messages and/or PSCCH messages. The second set of resources 815 may additionally include a guard symbol.

The third set of resources 820 may include a configurable AGC resource 825c that includes a sidelink control message and/or a sidelink reference signal, such as one or more DMRSs and/or CSI-RSs, among other examples. For example, the Rx UE 120b may receive the third set of resources 820 including a sidelink control message and/or a sidelink reference signal, via the configurable AGC resource 825c, and may refrain from perform AGC training using the AGC message. The third set of resources 820 may further include one or more signals, such as one or more PSSCH messages and/or PSCCH messages. The third set of resources 820 may additionally include a guard symbol.

In some aspects, a quantity of symbols for the AGC configuration may be variable. For example, a resource set may include a portion of a resource for the AGC message and/or may include multiple resources for the AGC message (for example, messages associated with larger subcarrier spacing may require more than one AGC symbol and/or AGC message to perform AGC training). In some aspects, a duration of time for the Rx UE 120b to perform AGC training may depend on a variation of receive power levels, and/or a capability of the Rx UE 120b, among other examples. As a result, a quantity of signal samples and/or a time duration used to complete AGC training (for example, achieve convergence on the outer loop AGC so that an estimated gain for the one or more receive chain components is within a desired accuracy, as described with reference to FIG. 6) may not be consistent. Thus, in some aspects, the AGC configuration may indicate a quantity of symbols for the AGC message, and/or the Tx UE 120a and/or Rx UE 120b may indicate a quantity of symbols for the AGC training as part of the configurable AGC symbol.

The contents of each configurable AGC resource 825 may be based on or otherwise associated with one or more AGC configurations identified by the Tx UE 120a (for example, as described with reference to FIG. 7). For example, the Tx UE 120a may identify (for example, independently, in accordance with signaling from a network node, and/or in accordance with signaling from the Rx UE 120b) an AGC configuration for each of resource sets 810, 815, and/or 820, and/or may identify a single AGC configuration that indicates whether each of configurable AGC resources 825a, 825b, and/or 825c includes an AGC message. For example, the Tx UE 120a may transmit, and the Rx UE 120b may receive, the AGC configuration for each of resource sets 810, 815, and/or 820, and/or may transmit a single AGC configuration that indicates whether each of configurable AGC resources 825a, 825b, and/or 825c includes an AGC message. In some other examples, the Tx UE 120a may transmit, and the Rx UE 120b may receive, an indication of whether each of resource sets 810, 815, and/or 820 includes a AGC message in accordance with the identified gain control configuration. In some other examples, the Tx UE 120a may transmit, and the Rx UE 120b may receive, an indication for each of the resource sets 810, 815, or 820 indicating whether the respective resource set includes an AGC message in accordance with the identified gain control configuration.

In some aspects, the AGC configuration may indicate a quantity of symbols and/or a fractional quantity of symbols for the AGC message. In some other examples, the Tx UE 120a and/or the Rx UE 120b may identify a quantity of symbols and/or a fractional quantity of symbols for the AGC message and may transmit an indication to the Rx UE 120b or the Tx UE 120a, respectively. In some aspects, the indication of whether the configurable AGC resource 825 includes an AGC message includes an indication of the quantity of symbols and/or the fractional quantity of symbols for the AGC message. In some examples, the Tx UE 120a and/or the Rx UE 120b may communicate an indication of the quantity and/or fractional quantity of symbols for each set of resources 810, 815, and/or 825 and/or may communicate a single indication including the quantity and/or fractional quantity of symbols for each set of resources 810, 815, and/or 825.

Thus, the Tx UE 120a may identify an AGC configuration and the Tx UE 120a and/or the Rx UE 120b may identify and/or signal an AGC symbol duration.

FIG. 9 is a flowchart illustrating an example process 900 performed, for example, at a first UE or an apparatus of a first UE that supports sidelink AGC in accordance with the present disclosure. Example process 900 is an example where the apparatus or the first UE (for example, UE 120) performs operations associated with sidelink AGC.

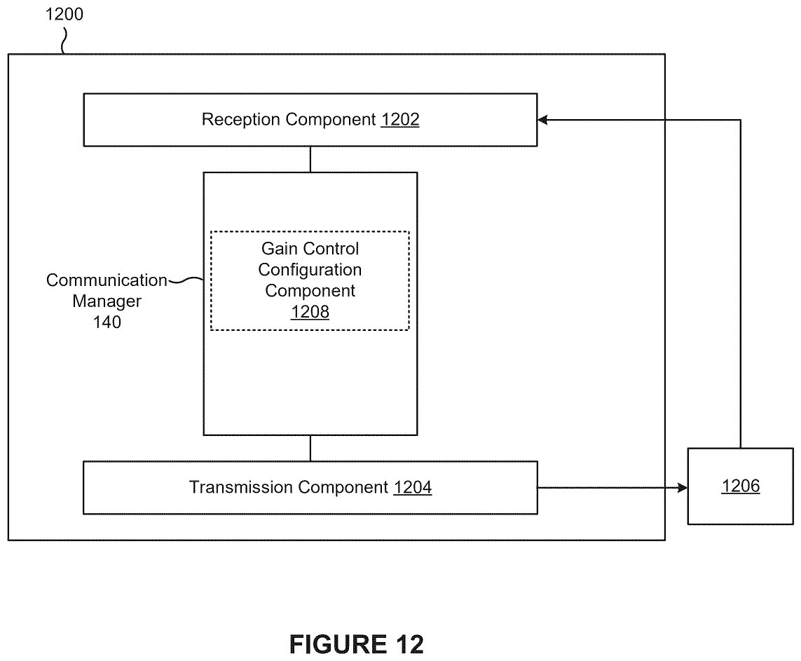

As shown in FIG. 9, in some aspects, process 900 may include identifying a gain control configuration associated with a set of time-frequency resources for communicating one or more signals between the first UE and a second UE (block 910). For example, the second UE (such as by using communication manager 140 or gain control configuration component 1208, depicted in FIG. 12) may identify a gain control configuration associated with a set of time-frequency resources for communicating one or more signals between the first UE and a second UE, as described above.

As further shown in FIG. 9, in some aspects, process 900 may include transmitting, to the second UE, an indication of whether the set of time-frequency resources includes a gain control message in accordance with the gain control configuration (block 920). For example, the second UE (such as by using communication manager 140 or transmission component 1204, depicted in FIG. 12) may transmit, to the second UE, an indication of whether the set of time-frequency resources includes a gain control message in accordance with the gain control configuration, as described above.

As further shown in FIG. 9, in some aspects, process 900 may include transmitting, via the set of time-frequency resources, the one or more signals in accordance with whether the set of time-frequency resources includes the gain control message (block 930). For example, the second UE (such as by using communication manager 140 or transmission component 1204, depicted in FIG. 12) may transmit, via the set of time-frequency resources, the one or more signals in accordance with whether the set of time-frequency resources includes the gain control message, as described above.

Process 900 may include additional aspects, such as any single aspect or any combination of aspects described below or in connection with one or more other processes described elsewhere herein.

In a first additional aspect, process 900 includes receiving, from at least one of a network node or the second UE, an indication of the gain control configuration, wherein identifying the gain control configuration is associated with receiving the indication of the gain control configuration.

In a second additional aspect, alone or in combination with the first aspect, receiving the indication of the gain control configuration comprises receiving the indication of the gain control configuration via at least one of a DCI message or a sidelink control information message.

In a third additional aspect, alone or in combination with one or more of the first and second aspects, process 900 includes receiving, from a network node, an indication of a first gain control configuration, wherein the gain control configuration includes a second gain control configuration that is different from the first gain control configuration.

In a fourth additional aspect, alone or in combination with one or more of the first through third aspects, process 900 includes receiving, from the second UE, feedback information associated with communications between the first UE and the second UE, wherein identifying the gain control configuration is associated with receiving the feedback information.

In a fifth additional aspect, alone or in combination with one or more of the first through fourth aspects, identifying the gain control configuration comprises identifying the gain control configuration in accordance with one or more parameters associated with communications between the first UE and the second UE.

In a sixth additional aspect, alone or in combination with one or more of the first through fifth aspects, the one or more parameters includes at least one of an MCS associated with the one or more signals, a channel quality index, an SNR, an RSRP, a quality-of-service associated with the one or more signals, a delay spread, a received signal strength, a decoding performance parameter, or a reference signal received quality.

In a seventh additional aspect, alone or in combination with one or more of the first through sixth aspects, the gain control configuration indicates whether a gain control procedure is to be applied to the set of time-frequency resources.

In an eighth additional aspect, alone or in combination with one or more of the first through seventh aspects, process 900 includes receiving, from a network node, an indication of a plurality of time-frequency resource sets for communications between the first UE and the second UE, wherein the gain control configuration indicates whether a gain control procedure is to be applied to each set of time-frequency resources of the plurality of time-frequency resource sets.

In a ninth additional aspect, alone or in combination with one or more of the first through eighth aspects, the gain control configuration includes a bitmap.

In a tenth additional aspect, alone or in combination with one or more of the first through ninth aspects, the gain control configuration indicates that the gain control procedure is to be applied to a first set of time-frequency resources of the plurality of time-frequency resource sets, and indicates that a subsequent set of time-frequency resources of the plurality of time-frequency resource sets is to be communicated independently of the gain control procedure.

In an eleventh additional aspect, alone or in combination with one or more of the first through tenth aspects, the set of time-frequency resources includes a time-frequency resource for communicating the gain control message.

In a twelfth additional aspect, alone or in combination with one or more of the first through eleventh aspects, an inclusion of the gain control message in the set of time-frequency resources enables a gain control procedure for the one or more signals.

In a thirteenth additional aspect, alone or in combination with one or more of the first through twelfth aspects, an absence of the gain control message in the set of time-frequency resources disables a gain control procedure for the one or more signals.

In a fourteenth additional aspect, alone or in combination with one or more of the first through thirteenth aspects, transmitting the one or more signals in accordance with whether the set of time-frequency resources includes the gain control message comprises transmitting at least one of a data message or a control message via a time-frequency resource, of the set of time-frequency resources, associated with the gain control message.

In a fifteenth additional aspect, alone or in combination with one or more of the first through fourteenth aspects, process 900 includes transmitting an indication of a second set of time-frequency resources for communicating an additional one or more signals in accordance with transmitting the one or more signals.

In a sixteenth additional aspect, alone or in combination with one or more of the first through fifteenth aspects, transmitting the one or more signals in accordance with whether the set of time-frequency resources includes the gain control message comprises transmitting the gain control message via a time-frequency resource, of the set of time-frequency resources, associated with the gain control message.

In a seventeenth additional aspect, alone or in combination with one or more of the first through sixteenth aspects, the indication of whether the set of time-frequency resources includes the gain control message further indicates whether a subsequent set of time-frequency resources includes a second gain control message.

In an eighteenth additional aspect, alone or in combination with one or more of the first through seventeenth aspects, process 900 includes transmitting a capability message indicating a capability of the first UE for identifying the gain control configuration.

In a nineteenth additional aspect, alone or in combination with one or more of the first through eighteenth aspects, process 900 includes receiving a capability message indicating a capability of the second UE for receiving the one or more signals in accordance with whether the set of time-frequency resources includes the gain control message.

In a twentieth additional aspect, alone or in combination with one or more of the first through nineteenth aspects, process 900 includes transmitting, to the second UE, an indication of a quantity of time-frequency resources, of the set of time-frequency resources, for communicating the gain control message.

In a twenty-first additional aspect, alone or in combination with one or more of the first through twentieth aspects, process 900 includes transmitting, to the second UE, an indication of a portion of a time-frequency resource, of the set of time-frequency resources, for communicating the gain control message.

Although FIG. 9 shows example blocks of process 900, in some aspects, process 900 may include additional blocks, fewer blocks, different blocks, or differently arranged blocks than those depicted in FIG. 9. Additionally or alternatively, two or more of the blocks of process 900 may be performed in parallel.

FIG. 10 is a flowchart illustrating an example process 1000 performed, for example, at a second UE or an apparatus of a second UE that supports sidelink AGC in accordance with the present disclosure. Example process 1000 is an example where the apparatus or the second UE (for example, UE 120) performs operations associated with sidelink AGC.

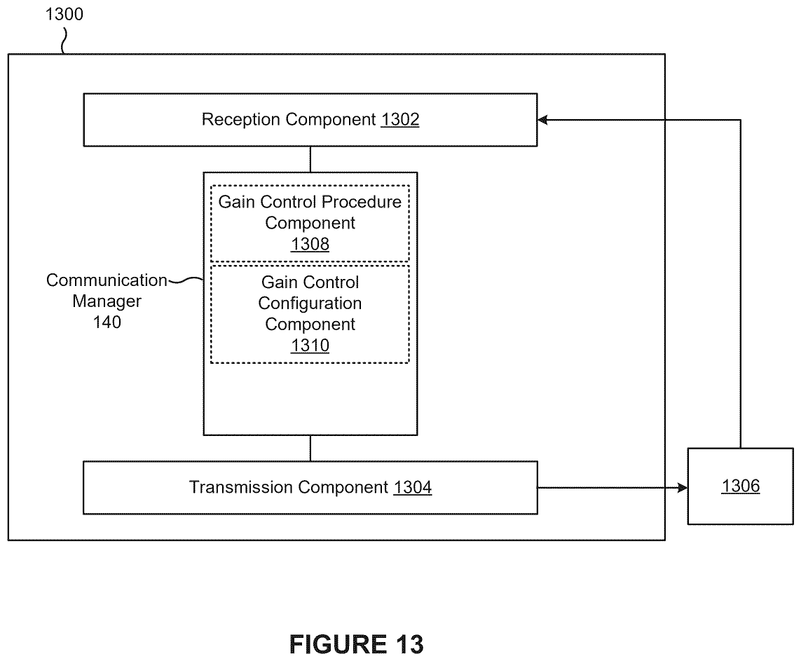

As shown in FIG. 10, in some aspects, process 1000 may include receiving, from a first UE, an indication of whether a set of time-frequency resources, for communicating one or more signals between the second UE and the first UE, includes a gain control message (block 1010). For example, the second UE (such as by using communication manager 140 or reception component 1302, depicted in FIG. 13) may receive, from a first UE, an indication of whether a set of time-frequency resources, for communicating one or more signals between the second UE and the first UE, includes a gain control message, as described above.

As further shown in FIG. 10, in some aspects, process 1000 may include receiving, during the set of time-frequency resources, the one or more signals in accordance with whether the set of time-frequency resources includes the gain control message (block 1020). For example, the second UE (such as by using communication manager 140 or reception component 1302, depicted in FIG. 13) may receive, during the set of time-frequency resources, the one or more signals in accordance with whether the set of time-frequency resources includes the gain control message, as described above.

Process 1000 may include additional aspects, such as any single aspect or any combination of aspects described below or in connection with one or more other processes described elsewhere herein.

In a first additional aspect, receiving the one or more signals in accordance with whether the set of time-frequency resources includes the gain control message comprises receiving the gain control message via a first time-frequency resource of the set of time-frequency resources, and performing a gain control procedure for the one or more signals.

In a second additional aspect, alone or in combination with the first aspect, performing the gain control procedure comprises measuring a power associated with the first time-frequency resource, training a power gain in association with measuring the power associated with the first time-frequency resource, and applying the power gain to each of the one or more signals.

In a third additional aspect, alone or in combination with one or more of the first and second aspects, receiving the one or more signals in accordance with whether the set of time-frequency resources includes the gain control message comprises receiving at least one of a data message or a control message via a time-frequency resource, of the set of time-frequency resources, associated with the gain control message.

In a fourth additional aspect, alone or in combination with one or more of the first through third aspects, process 1000 includes refraining from performing a gain control procedure for the one or more signals in accordance with receiving at least one of the data message or the control message via the time-frequency resource associated with the gain control message.

In a fifth additional aspect, alone or in combination with one or more of the first through fourth aspects, process 1000 includes transmitting, to at least one of the first UE or a network node, a capability message indicating a capability of the second UE for receiving the one or more signals in accordance with whether the set of time-frequency resources includes the gain control message.

In a sixth additional aspect, alone or in combination with one or more of the first through fifth aspects, process 1000 includes identifying a gain control configuration associated with the set of time-frequency resources for communicating the one or more signals between the first UE and the second UE.

In a seventh additional aspect, alone or in combination with one or more of the first through sixth aspects, process 1000 includes transmitting, to the first UE, an indication of the gain control configuration, wherein receiving the indication of whether the set of time-frequency resources includes the gain control message is associated with transmitting the indication of the gain control configuration.

In an eighth additional aspect, alone or in combination with one or more of the first through seventh aspects, transmitting the indication of the gain control configuration comprises transmitting the indication of the gain control configuration via a sidelink control information message.

In a ninth additional aspect, alone or in combination with one or more of the first through eighth aspects, process 1000 includes identifying one or more parameters associated with communications between the first UE and the second UE, wherein identifying the gain control configuration is associated with identifying the one or more parameters.

In a tenth additional aspect, alone or in combination with one or more of the first through ninth aspects, the one or more parameters include at least one of an MCS associated with the one or more signals, a channel quality index, an SNR, an RSRP, a quality-of-service associated with the one or more signals, a delay spread, a received signal strength, a decoding performance parameter, or a reference signal received quality.

In an eleventh additional aspect, alone or in combination with one or more of the first through tenth aspects, the gain control configuration indicates whether a gain control procedure is to be applied to the set of time-frequency resources.

In a twelfth additional aspect, alone or in combination with one or more of the first through eleventh aspects, process 1000 includes transmitting, to the first UE, feedback information associated with communications between the first UE and the second UE, wherein receiving the indication of whether the set of time-frequency resources includes the gain control message is associated with transmitting the feedback information.

In a thirteenth additional aspect, alone or in combination with one or more of the first through twelfth aspects, process 1000 includes receiving, from a network node, an indication of a plurality of time-frequency resource sets for communications between the first UE and the second UE.

In a fourteenth additional aspect, alone or in combination with one or more of the first through thirteenth aspects, receiving the indication of the plurality of time-frequency resource sets comprises receiving a configured grant including the indication of the plurality of time-frequency resource sets.

In a fifteenth additional aspect, alone or in combination with one or more of the first through fourteenth aspects, the set of time-frequency resources includes a time-frequency resource for communicating the gain control message.

In a sixteenth additional aspect, alone or in combination with one or more of the first through fifteenth aspects, an inclusion of the gain control message in the set of time-frequency resources enables a gain control procedure for the one or more signals.

In a seventeenth additional aspect, alone or in combination with one or more of the first through sixteenth aspects, an absence of the gain control message in the set of time-frequency resources disables a gain control procedure for the one or more signals.

In an eighteenth additional aspect, alone or in combination with one or more of the first through seventeenth aspects, process 1000 includes receiving an indication of a second set of time-frequency resources for communicating an additional one or more signals in accordance with receiving the one or more signals.

In a nineteenth additional aspect, alone or in combination with one or more of the first through eighteenth aspects, receiving the one or more signals in accordance with whether the set of time-frequency resources includes the gain control message comprises receiving the gain control message via a time-frequency resource, of the set of time-frequency resources, associated with the gain control message.

In a twentieth additional aspect, alone or in combination with one or more of the first through nineteenth aspects, the indication of whether the set of time-frequency resources includes the gain control message further indicates whether a subsequent set of time-frequency resources includes a second gain control message.

In a twenty-first additional aspect, alone or in combination with one or more of the first through twentieth aspects, process 1000 includes transmitting, to at least one of the first UE or a network node, a capability message indicating a capability of the second UE for receiving the indication of whether the set of time-frequency resources includes the gain control message.

In a twenty-second additional aspect, alone or in combination with one or more of the first through twenty-first aspects, process 1000 includes receiving an indication of a quantity of time-frequency resources, of the set of time-frequency resources, for communicating the gain control message.

In a twenty-third additional aspect, alone or in combination with one or more of the first through twenty-second aspects, process 1000 includes receiving an indication of a portion of a time-frequency resource, of the set of time-frequency resources, for communicating the gain control message.

Although FIG. 10 shows example blocks of process 1000, in some aspects, process 1000 may include additional blocks, fewer blocks, different blocks, or differently arranged blocks than those depicted in FIG. 10. Additionally or alternatively, two or more of the blocks of process 1000 may be performed in parallel.

FIG. 11 is a flowchart illustrating an example process 1100 performed, for example, at a network node or an apparatus of a network node that supports sidelink AGC in accordance with the present disclosure. Example process 1100 is an example where the apparatus or the network node (for example, network node 110) performs operations associated with sidelink AGC.

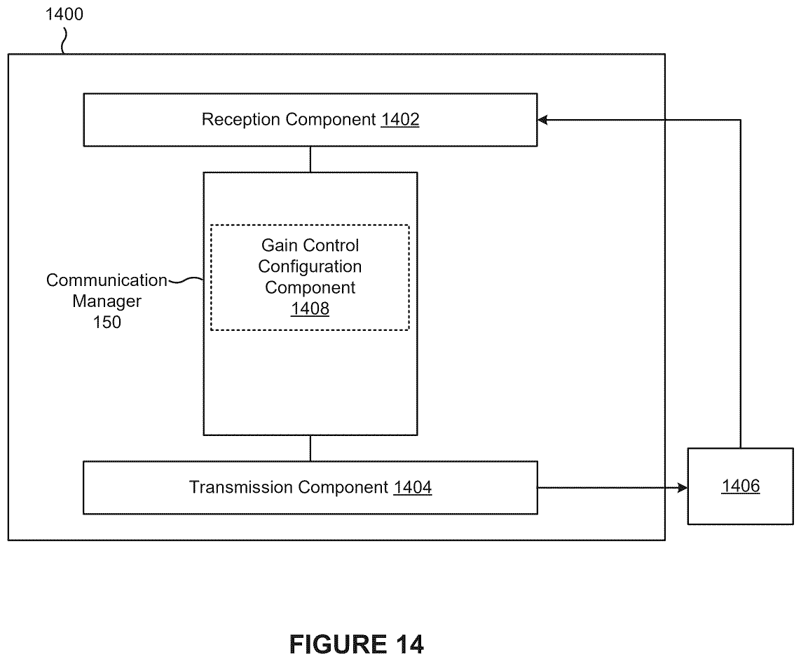

As shown in FIG. 11, in some aspects, process 1100 may include transmitting, to at least one of a first UE or a second UE, an indication of a set of time-frequency resources for communicating one or more signals between the first UE and the second UE (block 1110). For example, the network node (such as by using communication manager 150 or transmission component 1404, depicted in FIG. 14) may transmit, to at least one of a first UE or a second UE, an indication of a set of time-frequency resources for communicating one or more signals between the first UE and the second UE, as described above.

As further shown in FIG. 11, in some aspects, process 1100 may include transmitting, to the first UE, a gain control configuration associated with the set of time-frequency resources (block 1120). For example, the network node (such as by using communication manager 150 or transmission component 1404, depicted in FIG. 14) may transmit, to the first UE, a gain control configuration associated with the set of time-frequency resources, as described above.

Process 1100 may include additional aspects, such as any single aspect or any combination of aspects described below or in connection with one or more other processes described elsewhere herein.

In a first additional aspect, process 1100 includes identifying the gain control configuration in accordance with one or more parameters associated with communications between the first UE and the second UE, wherein transmitting the gain control configuration is associated with identifying the gain control configuration.

In a second additional aspect, alone or in combination with the first aspect, the one or more parameters include at least one of a quantity of UEs scheduled for communications with the second UE, a multiplexing scheme associated with the communications between the first UE and the second UE, or a transmission type associated with the one or more signals.

In a third additional aspect, alone or in combination with one or more of the first and second aspects, transmitting the indication of the set of time-frequency resources comprises transmitting a configured grant including the indication of the set of time-frequency resources.

In a fourth additional aspect, alone or in combination with one or more of the first through third aspects, process 1100 includes receiving a capability message indicating a capability of the first UE for identifying the gain control configuration.

In a fifth additional aspect, alone or in combination with one or more of the first through fourth aspects, process 1100 includes receiving a capability message indicating a capability of the second UE for receiving the one or more signals in accordance with the gain control configuration.

In a sixth additional aspect, alone or in combination with one or more of the first through fifth aspects, transmitting the indication of the gain control configuration comprises transmitting the gain control configuration via a DCI message.

In a seventh additional aspect, alone or in combination with one or more of the first through sixth aspects, process 1100 includes transmitting an indication of a plurality of time-frequency resource sets for communications between the first UE and the second UE, wherein the gain control configuration indicates whether a gain control procedure is to be applied to each set of time-frequency resources of the plurality of time-frequency resource sets.

In an eighth additional aspect, alone or in combination with one or more of the first through seventh aspects, the gain control configuration includes a bitmap.

In a ninth additional aspect, alone or in combination with one or more of the first through eighth aspects, the gain control configuration indicates that the gain control procedure is to be applied to a first set of time-frequency resources of the plurality of time-frequency resource sets, and indicates that a subsequent set of time-frequency resources of the plurality of time-frequency resource sets is to be communicated independently of the gain control procedure.

In a tenth additional aspect, alone or in combination with one or more of the first through ninth aspects, the set of time-frequency resources includes a time-frequency resource for communicating a gain control message.

Although FIG. 11 shows example blocks of process 1100, in some aspects, process 1100 may include additional blocks, fewer blocks, different blocks, or differently arranged blocks than those depicted in FIG. 11. Additionally or alternatively, two or more of the blocks of process 1100 may be performed in parallel.

FIG. 12 is a diagram of an example apparatus 1200 for wireless communication that supports sidelink AGC in accordance with the present disclosure. The apparatus 1200 may be a first UE, or a first UE may include the apparatus 1200. In some aspects, the apparatus 1200 includes a reception component 1202, a transmission component 1204, and a communication manager 140, which may be in communication with one another (for example, via one or more buses). As shown, the apparatus 1200 may communicate with another apparatus 1206 (such as a UE, a network node, or another wireless communication device) using the reception component 1202 and the transmission component 1204.

In some aspects, the apparatus 1200 may be configured to and/or operable to perform one or more operations described herein in connection with FIGS. 7-8. Additionally or alternatively, the apparatus 1200 may be configured to and/or operable to perform one or more processes described herein, such as process 900 of FIG. 9, and/or process 1000 of FIG. 10. In some aspects, the apparatus 1200 may include one or more components of the first UE described above in connection with FIG. 1 and FIG. 2.

The reception component 1202 may receive communications, such as reference signals, control information, and/or data communications, from the apparatus 1206. The reception component 1202 may provide received communications to one or more other components of the apparatus 1200, such as the communication manager 140. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1202 may include one or more antennas, one or more modems, one or more demodulators, one or more MIMO detectors, one or more receive processors, one or more controllers/processors, and/or one or more memories of the first UE described above in connection with FIG. 1 and FIG. 2.

The transmission component 1204 may transmit communications, such as reference signals, control information, and/or data communications, to the apparatus 1206. In some aspects, the communication manager 140 may generate communications and may transmit the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, one or more modems, one or more modulators, one or more transmit MIMO processors, one or more transmit processors, one or more controllers/processors, and/or one or more memories of the first UE described above in connection with FIG. 1 and FIG. 2. In some aspects, the transmission component 1204 may be co-located with the reception component 1202 in one or more transceivers.

The communication manager 140 may identify a gain control configuration associated with a set of time-frequency resources for communicating one or more signals between the first UE and a second UE. The communication manager 140 may transmit or may cause the transmission component 1204 to transmit, to the second UE, an indication of whether the set of time-frequency resources includes a gain control message in accordance with the gain control configuration. The communication manager 140 may transmit or may cause the transmission component 1204 to transmit, via the set of time-frequency resources, the one or more signals in accordance with whether the set of time-frequency resources includes the gain control message. In some aspects, the communication manager 140 may perform one or more operations described elsewhere herein as being performed by one or more components of the communication manager 140.

The communication manager 140 may include one or more controllers/processors, and/or one or more memories of the first UE described above in connection with FIG. 1 and FIG. 2. In some aspects, the communication manager 140 includes a set of components, such as a gain control configuration component 1208. Alternatively, the set of components may be separate and distinct from the communication manager 140. In some aspects, one or more components of the set of components may include or may be implemented within one or more controllers/processors, and/or one or more memories of the first UE described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The gain control configuration component 1208 may identify a gain control configuration associated with a set of time-frequency resources for communicating one or more signals between the first UE and a second UE. The transmission component 1204 may transmit, to the second UE, an indication of whether the set of time-frequency resources includes a gain control message in accordance with the gain control configuration. The transmission component 1204 may transmit, via the set of time-frequency resources, the one or more signals in accordance with whether the set of time-frequency resources includes the gain control message.

The reception component 1202 may receive, from at least one of a network node or the second UE, an indication of the gain control configuration, wherein identifying the gain control configuration is associated with receiving the indication of the gain control configuration.

The reception component 1202 may receive, from a network node, an indication of a first gain control configuration, wherein the gain control configuration includes a second gain control configuration that is different from the first gain control configuration.

The reception component 1202 may receive the indication of the gain control configuration via at least one of a DCI message or a sidelink control information message.

The reception component 1202 may receive, from the second UE, feedback information associated with communications between the first UE and the second UE, wherein identifying the gain control configuration is associated with receiving the feedback information.

The gain control configuration component may identify the gain control configuration in accordance with one or more parameters associated with communications between the first UE and the second UE.

The reception component 1202 may receive, from a network node, an indication of a plurality of time-frequency resource sets for communications between the first UE and the second UE, wherein the gain control configuration indicates whether a gain control procedure is to be applied to each set of time-frequency resources of the plurality of time-frequency resource sets.

The transmission component 1204 may transmit at least one of a data message or a control message via a time-frequency resource, of the set of time-frequency resources, associated with the gain control message.

The transmission component 1204 may transmit an indication of a second set of time-frequency resources for communicating an additional one or more signals in accordance with transmitting the one or more signals.

The transmission component 1204 may transmit the gain control message via a time-frequency resource, of the set of time-frequency resources, associated with the gain control message.

The transmission component 1204 may transmit a capability message indicating a capability of the first UE for identifying the gain control configuration.

The reception component 1202 may receive a capability message indicating a capability of the second UE for receiving the one or more signals in accordance with whether the set of time-frequency resources includes the gain control message.

The transmission component 1204 may transmit, to the second UE, an indication of a quantity of time-frequency resources, of the set of time-frequency resources, for communicating the gain control message.

The transmission component 1204 may transmit, to the second UE, an indication of a portion of a time-frequency resource, of the set of time-frequency resources, for communicating the gain control message.

The quantity and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally or alternatively, a set of (one or more) components shown in FIG. 12 may perform one or more functions described as being performed by another set of components shown in FIG. 12.

FIG. 13 is a diagram of an example apparatus 1300 for wireless communication that supports configurable sidelink AGC in accordance with the present disclosure. The apparatus 1300 may be a second UE, or a second UE may include the apparatus 1300. In some aspects, the apparatus 1300 includes a reception component 1302, a transmission component 1304, and a communication manager 140, which may be in communication with one another (for example, via one or more buses). As shown, the apparatus 1300 may communicate with another apparatus 1306 (such as a UE, a network node, or another wireless communication device) using the reception component 1302 and the transmission component 1304.

In some aspects, the apparatus 1300 may be configured to and/or operable to perform one or more operations described herein in connection with FIGS. 6-7. Additionally or alternatively, the apparatus 1300 may be configured to and/or operable to perform one or more processes described herein, such as process 900 of FIG. 9, and/or process 1000 of FIG. 10. In some aspects, the apparatus 1300 may include one or more components of the second UE described above in connection with FIG. 1 and FIG. 2.

The reception component 1302 may receive communications, such as reference signals, control information, and/or data communications, from the apparatus 1306. The reception component 1302 may provide received communications to one or more other components of the apparatus 1300, such as the communication manager 140. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1302 may include one or more antennas, one or more modems, one or more demodulators, one or more MIMO detectors, one or more receive processors, one or more controllers/processors, and/or one or more memories of the second UE described above in connection with FIG. 1 and FIG. 2.

The transmission component 1304 may transmit communications, such as reference signals, control information, and/or data communications, to the apparatus 1306. In some aspects, the communication manager 140 may generate communications and may transmit the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, one or more modems, one or more modulators, one or more transmit MIMO processors, one or more transmit processors, one or more controllers/processors, and/or one or more memories of the second UE described above in connection with FIG. 1 and FIG. 2. In some aspects, the transmission component 1304 may be co-located with the reception component 1302 in one or more transceivers.

The communication manager 140 may receive or may cause the reception component 1302 to receive, from a first UE, an indication of whether a set of time-frequency resources, for communicating one or more signals between the second UE and the first UE, includes a gain control message. The communication manager 140 may receive or may cause the reception component 1302 to receive, during the set of time-frequency resources, the one or more signals in accordance with whether the set of time-frequency resources includes the gain control message. In some aspects, the communication manager 140 may perform one or more operations described elsewhere herein as being performed by one or more components of the communication manager 140.

The communication manager 140 may include one or more controllers/processors, and/or one or more memories of the second UE described above in connection with FIG. 1 and FIG. 2. In some aspects, the communication manager 140 includes a set of components, such as a gain control procedure component 1308, and/or a gain control configuration component 1310. Alternatively, the set of components may be separate and distinct from the communication manager 140. In some aspects, one or more components of the set of components may include or may be implemented within one or more controllers/processors, and/or one or more memories of the second UE described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive, from a first UE, an indication of whether a set of time-frequency resources, for communicating one or more signals between the second UE and the first UE, includes a gain control message. The reception component 1302 may receive, during the set of time-frequency resources, the one or more signals in accordance with whether the set of time-frequency resources includes the gain control message. The reception component 1302 may receive the gain control message via a first time-frequency resource of the set of time-frequency resources.

The gain control procedure component 1308 may perform a gain control procedure for the one or more signals. The gain control procedure component 1308 may measure a power associated with the first time-frequency resource. The gain control procedure component 1308 may train a power gain in association with measuring the power associated with the first time-frequency resource. The gain control procedure component 1308 may apply the power gain to each of the one or more signals. The gain control procedure component 1308 may refrain from performing a gain control procedure for the one or more signals in accordance with receiving at least one of the data message or the control message via the time-frequency resource associated with the gain control message.

The reception component 1302 may receiving at least one of a data message or a control message via a time-frequency resource, of the set of time-frequency resources, associated with the gain control message.

The transmission component 1304 may transmit, to at least one of the first UE or a network node, a capability message indicating a capability of the second UE for receiving the one or more signals in accordance with whether the set of time-frequency resources includes the gain control message.

The gain control configuration component 1310 may identify a gain control configuration associated with the set of time-frequency resources for communicating the one or more signals between the first UE and the second UE.

The transmission component 1304 may transmit, to the first UE, an indication of the gain control configuration, wherein receiving the indication of whether the set of time-frequency resources includes the gain control message is associated with transmitting the indication of the gain control configuration. The transmission component 1304 may transmit the indication of the gain control configuration via a sidelink control information message.

The gain control configuration component 1310 may identify one or more parameters associated with communications between the first UE and the second UE, wherein identifying the gain control configuration is associated with identifying the one or more parameters.

The transmission component 1304 may transmit, to the first UE, feedback information associated with communications between the first UE and the second UE, wherein receiving the indication of whether the set of time-frequency resources includes the gain control message is associated with transmitting the feedback information.

The reception component 1302 may receive, from a network node, an indication of a plurality of time-frequency resource sets for communications between the first UE and the second UE.

The reception component 1302 may receive an indication of a second set of time-frequency resources for communicating an additional one or more signals in accordance with receiving the one or more signals. The reception component 1302 may receive the gain control message via a time-frequency resource, of the set of time-frequency resources, associated with the gain control message.

The transmission component 1304 may transmit, to at least one of the first UE or a network node, a capability message indicating a capability of the second UE for receiving the indication of whether the set of time-frequency resources includes the gain control message.

The reception component 1302 may receive an indication of a quantity of time-frequency resources, of the set of time-frequency resources, for communicating the gain control message.

The reception component 1302 may receive an indication of a portion of a time-frequency resource, of the set of time-frequency resources, for communicating the gain control message.

The quantity and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally or alternatively, a set of (one or more) components shown in FIG. 13 may perform one or more functions described as being performed by another set of components shown in FIG. 13.

FIG. 14 is a diagram of an example apparatus 1400 for wireless communication that supports configurable sidelink AGC in accordance with the present disclosure. The apparatus 1400 may be a network node, or a network node may include the apparatus 1400. In some aspects, the apparatus 1400 includes a reception component 1402, a transmission component 1404, and a communication manager 150, which may be in communication with one another (for example, via one or more buses). As shown, the apparatus 1400 may communicate with another apparatus 1406 (such as a UE, a network node, or another wireless communication device) using the reception component 1402 and the transmission component 1404.

In some aspects, the apparatus 1400 may be configured to and/or operable to perform one or more operations described herein in connection with FIGS. 6-7. Additionally or alternatively, the apparatus 1400 may be configured to and/or operable to perform one or more processes described herein, such as process 1100 of FIG. 11. In some aspects, the apparatus 1400 may include one or more components of the network node described above in connection with FIG. 1 and FIG. 2.

The reception component 1402 may receive communications, such as reference signals, control information, and/or data communications, from the apparatus 1406. The reception component 1402 may provide received communications to one or more other components of the apparatus 1400, such as the communication manager 150. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 1402 may include one or more antennas, one or more modems, one or more demodulators, one or more MIMO detectors, one or more receive processors, one or more controllers/processors, and/or one or more memories of the network node described above in connection with FIG. 1 and FIG. 2.

The transmission component 1404 may transmit communications, such as reference signals, control information, and/or data communications, to the apparatus 1406. In some aspects, the communication manager 150 may generate communications and may transmit the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, one or more modems, one or more modulators, one or more transmit MIMO processors, one or more transmit processors, one or more controllers/processors, and/or one or more memories of the network node described above in connection with FIG. 1 and FIG. 2. In some aspects, the transmission component 1404 may be co-located with the reception component 1402 in one or more transceivers.

The communication manager 150 may transmit or may cause the transmission component 1404 to transmit, to at least one of a first UE or a second UE, an indication of a set of time-frequency resources for communicating one or more signals between the first UE and the second UE. The communication manager 150 may transmit or may cause the transmission component 1404 to transmit, to the first UE, a gain control configuration associated with the set of time-frequency resources. In some aspects, the communication manager 150 may perform one or more operations described elsewhere herein as being performed by one or more components of the communication manager 150.

The communication manager 150 may include one or more controllers/processors, one or more memories, one or more schedulers, and/or one or more communication units of the network node described above in connection with FIG. 1 and FIG. 2. In some aspects, the communication manager 150 includes a set of components, such as a gain control configuration component 1408. Alternatively, the set of components may be separate and distinct from the communication manager 150. In some aspects, one or more components of the set of components may include or may be implemented within one or more controllers/processors, one or more memories, one or more schedulers, and/or one or more communication units of the network node described above in connection with FIG. 1 and FIG. 2. Additionally or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The transmission component 1404 may transmit, to at least one of a first UE or a second UE, an indication of a set of time-frequency resources for communicating one or more signals between the first UE and the second UE. The transmission component 1404 may transmit, to the first UE, a gain control configuration associated with the set of time-frequency resources.

The gain control configuration component 1408 may identify the gain control configuration in accordance with one or more parameters associated with communications between the first UE and the second UE, wherein transmitting the gain control configuration is associated with identifying the gain control configuration.

The transmission component 1404 may transmit a configured grant including the indication of the set of time-frequency resources.

The reception component 1402 may receive a capability message indicating a capability of the first UE for identifying the gain control configuration.

The reception component 1402 may receive a capability message indicating a capability of the second UE for receiving the one or more signals in accordance with the gain control configuration.

The transmission component 1404 may transmit the gain control configuration via a DCI message. The transmission component 1404 may transmit an indication of a plurality of time-frequency resource sets for communications between the first UE and the second UE, wherein the gain control configuration indicates whether a gain control procedure is to be applied to each set of time-frequency resources of the plurality of time-frequency resource sets.

The quantity and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a first user equipment (UE), comprising: identifying a gain control configuration associated with a set of time-frequency resources for communicating one or more signals between the first UE and a second UE; transmitting, to the second UE, an indication of whether the set of time-frequency resources includes a gain control message in accordance with the gain control configuration; and transmitting, via the set of time-frequency resources, the one or more signals in accordance with whether the set of time-frequency resources includes the gain control message.

Aspect 2: The method of Aspect 1, further comprising: receiving, from at least one of a network node or the second UE, an indication of the gain control configuration, wherein identifying the gain control configuration is associated with receiving the indication of the gain control configuration.

Aspect 3: The method of Aspect 2, wherein receiving the indication of the gain control configuration comprises: receiving the indication of the gain control configuration via at least one of a downlink control information message or a sidelink control information message.

Aspect 4: The method of any of Aspects 1-3, further comprising: receiving, from a network node, an indication of a first gain control configuration, wherein the gain control configuration includes a second gain control configuration that is different from the first gain control configuration.

Aspect 5: The method of any of Aspects 1-4, further comprising: receiving, from the second UE, feedback information associated with communications between the first UE and the second UE, wherein identifying the gain control configuration is associated with receiving the feedback information.

Aspect 6: The method of any of Aspects 1-5, wherein identifying the gain control configuration comprises: identifying the gain control configuration in accordance with one or more parameters associated with communications between the first UE and the second UE.

Aspect 7: The method of Aspect 6, wherein the one or more parameters includes at least one of: a modulation coding scheme associated with the one or more signals, a channel quality index, a signal-to-noise ratio, a reference signal received power, a quality-of-service associated with the one or more signals, a delay spread, a received signal strength, a decoding performance parameter, or a reference signal received quality.

Aspect 8: The method of any of Aspects 1-7, wherein the gain control configuration indicates whether a gain control procedure is to be applied to the set of time-frequency resources.

Aspect 9: The method of any of Aspects 1-8, further comprising: receiving, from a network node, an indication of a plurality of time-frequency resource sets for communications between the first UE and the second UE, wherein the gain control configuration indicates whether a gain control procedure is to be applied to each set of time-frequency resources of the plurality of time-frequency resource sets.

Aspect 10: The method of Aspect 9, wherein the gain control configuration includes a bitmap.

Aspect 11: The method of any of Aspects 9-10, wherein the gain control configuration indicates that the gain control procedure is to be applied to a first set of time-frequency resources of the plurality of time-frequency resource sets, and indicates that a subsequent set of time-frequency resources of the plurality of time-frequency resource sets is to be communicated independently of the gain control procedure.

Aspect 12: The method of any of Aspects 1-11, wherein the set of time-frequency resources includes a time-frequency resource for communicating the gain control message.

Aspect 13: The method of Aspect 12, wherein an inclusion of the gain control message in the set of time-frequency resources enables a gain control procedure for the one or more signals.

Aspect 14: The method of any of Aspects 12-13, wherein an absence of the gain control message in the set of time-frequency resources disables a gain control procedure for the one or more signals.

Aspect 15: The method of any of Aspects 1-14, wherein transmitting the one or more signals in accordance with whether the set of time-frequency resources includes the gain control message comprises: transmitting at least one of a data message or a control message via a time-frequency resource, of the set of time-frequency resources, associated with the gain control message.

Aspect 16: The method of any of Aspects 1-15, further comprising: transmitting an indication of a second set of time-frequency resources for communicating an additional one or more signals in accordance with transmitting the one or more signals.

Aspect 17: The method of any of Aspects 1-14 and 16, wherein transmitting the one or more signals in accordance with whether the set of time-frequency resources includes the gain control message comprises: transmitting the gain control message via a time-frequency resource, of the set of time-frequency resources, associated with the gain control message.

Aspect 18: The method of any of Aspects 1-17, wherein the indication of whether the set of time-frequency resources includes the gain control message further indicates whether a subsequent set of time-frequency resources includes a second gain control message.

Aspect 19: The method of any of Aspects 1-18, further comprising: transmitting a capability message indicating a capability of the first UE for identifying the gain control configuration.

Aspect 20: The method of any of Aspects 1-19, further comprising: receiving a capability message indicating a capability of the second UE for receiving the one or more signals in accordance with whether the set of time-frequency resources includes the gain control message.

Aspect 21: The method of any of Aspects 1-20, further comprising: transmitting, to the second UE, an indication of a quantity of time-frequency resources, of the set of time-frequency resources, for communicating the gain control message.

Aspect 22: The method of any of Aspects 1-21, further comprising: transmitting, to the second UE, an indication of a portion of a time-frequency resource, of the set of time-frequency resources, for communicating the gain control message.

Aspect 23: A method of wireless communication performed by a second user equipment (UE), comprising: receiving, from a first UE, an indication of whether a set of time-frequency resources, for communicating one or more signals between the second UE and the first UE, includes a gain control message; and receiving, during the set of time-frequency resources, the one or more signals in accordance with whether the set of time-frequency resources includes the gain control message.

Aspect 24: The method of Aspect 23, wherein receiving the one or more signals in accordance with whether the set of time-frequency resources includes the gain control message comprises: receiving the gain control message via a first time-frequency resource of the set of time-frequency resources; and performing a gain control procedure for the one or more signals.

Aspect 25: The method of Aspect 24, wherein performing the gain control procedure comprises: measuring a power associated with the first time-frequency resource; training a power gain in association with measuring the power associated with the first time-frequency resource; and applying the power gain to each of the one or more signals.

Aspect 26: The method of Aspect 23, wherein receiving the one or more signals in accordance with whether the set of time-frequency resources includes the gain control message comprises: receiving at least one of a data message or a control message via a time-frequency resource, of the set of time-frequency resources, associated with the gain control message.

Aspect 27: The method of Aspect 26, further comprising: refraining from performing a gain control procedure for the one or more signals in accordance with receiving at least one of the data message or the control message via the time-frequency resource associated with the gain control message.

Aspect 28: The method of any of Aspects 23-27, further comprising: transmitting, to at least one of the first UE or a network node, a capability message indicating a capability of the second UE for receiving the one or more signals in accordance with whether the set of time-frequency resources includes the gain control message.

Aspect 29: The method of any of Aspects 23-28, further comprising: identifying a gain control configuration associated with the set of time-frequency resources for communicating the one or more signals between the first UE and the second UE.

Aspect 30: The method of Aspect 29, further comprising: transmitting, to the first UE, an indication of the gain control configuration, wherein receiving the indication of whether the set of time-frequency resources includes the gain control message is associated with transmitting the indication of the gain control configuration.

Aspect 31: The method of Aspect 30, wherein transmitting the indication of the gain control configuration comprises: transmitting the indication of the gain control configuration via a sidelink control information message.

Aspect 32: The method of any of Aspects 29-31, further comprising: identifying one or more parameters associated with communications between the first UE and the second UE, wherein identifying the gain control configuration is associated with identifying the one or more parameters.

Aspect 33: The method of Aspect 32, wherein the one or more parameters include at least one of: a modulation and coding scheme associated with the one or more signals, a channel quality index, a signal-to-noise ratio, a reference signal received power, a quality-of-service associated with the one or more signals, a delay spread, a received signal strength, a decoding performance parameter, or a reference signal received quality.

Aspect 34: The method of any of Aspects 29-33, wherein the gain control configuration indicates whether a gain control procedure is to be applied to the set of time-frequency resources.

Aspect 35: The method of any of Aspects 23-34, further comprising: transmitting, to the first UE, feedback information associated with communications between the first UE and the second UE, wherein receiving the indication of whether the set of time-frequency resources includes the gain control message is associated with transmitting the feedback information.

Aspect 36: The method of any of Aspects 23-35, further comprising: receiving, from a network node, an indication of a plurality of time-frequency resource sets for communications between the first UE and the second UE.

Aspect 37: The method of Aspect 36, wherein receiving the indication of the plurality of time-frequency resource sets comprises: receiving a configured grant including the indication of the plurality of time-frequency resource sets.

Aspect 38: The method of any of Aspects 23-37, wherein the set of time-frequency resources includes a time-frequency resource for communicating the gain control message.

Aspect 39: The method of Aspect 38, wherein an inclusion of the gain control message in the set of time-frequency resources enables a gain control procedure for the one or more signals.

Aspect 40: The method of any of Aspects 38-39, wherein an absence of the gain control message in the set of time-frequency resources disables a gain control procedure for the one or more signals.

Aspect 41: The method of any of Aspects 23-40, further comprising: receiving an indication of a second set of time-frequency resources for communicating an additional one or more signals in accordance with receiving the one or more signals.

Aspect 42: The method of any of Aspects 23-41, wherein receiving the one or more signals in accordance with whether the set of time-frequency resources includes the gain control message comprises: receiving the gain control message via a time-frequency resource, of the set of time-frequency resources, associated with the gain control message.

Aspect 43: The method of any of Aspects 23-42, wherein the indication of whether the set of time-frequency resources includes the gain control message further indicates whether a subsequent set of time-frequency resources includes a second gain control message.

Aspect 44: The method of any of Aspects 23-43, further comprising: transmitting, to at least one of the first UE or a network node, a capability message indicating a capability of the second UE for receiving the indication of whether the set of time-frequency resources includes the gain control message.

Aspect 45: The method of any of Aspects 23-44, further comprising: receiving an indication of a quantity of time-frequency resources, of the set of time-frequency resources, for communicating the gain control message.

Aspect 46: The method of any of Aspects 23-45, further comprising: receiving an indication of a portion of a time-frequency resource, of the set of time-frequency resources, for communicating the gain control message.

Aspect 47: A method of wireless communication performed by a network node, comprising: transmitting, to at least one of a first user equipment (UE) or a second UE, an indication of a set of time-frequency resources for communicating one or more signals between the first UE and the second UE; and transmitting, to the first UE, a gain control configuration associated with the set of time-frequency resources.

Aspect 48: The method of Aspect 47, further comprising: identifying the gain control configuration in accordance with one or more parameters associated with communications between the first UE and the second UE, wherein transmitting the gain control configuration is associated with identifying the gain control configuration.

Aspect 49: The method of Aspect 48, wherein the one or more parameters include at least one of: a quantity of UEs scheduled for communications with the second UE, a multiplexing scheme associated with the communications between the first UE and the second UE, or a transmission type associated with the one or more signals.

Aspect 50: The method of any of Aspects 47-49, wherein transmitting the indication of the set of time-frequency resources comprises: transmitting a configured grant including the indication of the set of time-frequency resources.

Aspect 51: The method of any of Aspects 47-50, further comprising: receiving a capability message indicating a capability of the first UE for identifying the gain control configuration.

Aspect 52: The method of any of Aspects 47-51, further comprising: receiving a capability message indicating a capability of the second UE for receiving the one or more signals in accordance with the gain control configuration.

Aspect 53: The method of any of Aspects 47-52, wherein transmitting the indication of the gain control configuration comprises: transmitting the gain control configuration via a downlink control information message.

Aspect 54: The method of any of Aspects 47-53, further comprising: transmitting an indication of a plurality of time-frequency resource sets for communications between the first UE and the second UE, wherein the gain control configuration indicates whether a gain control procedure is to be applied to each set of time-frequency resources of the plurality of time-frequency resource sets.

Aspect 55: The method of Aspect 54, wherein the gain control configuration includes a bitmap.

Aspect 56: The method of any of Aspects 54-55, wherein the gain control configuration indicates that the gain control procedure is to be applied to a first set of time-frequency resources of the plurality of time-frequency resource sets, and indicates that a subsequent set of time-frequency resources of the plurality of time-frequency resource sets is to be communicated independently of the gain control procedure.

Aspect 57: The method of any of Aspects 47-56, wherein the set of time-frequency resources includes a time-frequency resource for communicating a gain control message.

Aspect 58: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-57.

Aspect 59: An apparatus for wireless communication at a device, the apparatus comprising one or more memories and one or more processors coupled to the one or more memories, the one or more processors configured to cause the device to perform the method of one or more of Aspects 1-57.

Aspect 60: An apparatus for wireless communication, the apparatus comprising at least one means for performing the method of one or more of Aspects 1-57.

Aspect 61: A non-transitory computer-readable medium storing code for wireless communication, the code comprising instructions executable by one or more processors to perform the method of one or more of Aspects 1-57.

Aspect 62: A non-transitory computer-readable medium storing a set of instructions for wireless communication, the set of instructions comprising one or more instructions that, when executed by one or more processors of a device, cause the device to perform the method of one or more of Aspects 1-57.

Aspect 63: A device for wireless communication, the device comprising a processing system that includes one or more processors and one or more memories coupled with the one or more processors, the processing system configured to cause the device to perform the method of one or more of Aspects 1-57.

Aspect 64: An apparatus for wireless communication at a device, the apparatus comprising one or more memories and one or more processors coupled to the one or more memories, the one or more processors individually or collectively configured to cause the device to perform the method of one or more of Aspects 1-57.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A first user equipment (UE) for wireless communication, comprising:
a processing system that includes one or more processors and one or more memories coupled with the one or more processors, the processing system configured to cause the UE to:
identify a gain control configuration associated with a set of time-frequency resources for communicating one or more signals between the first UE and a second UE;
transmit, to the second UE, an indication of whether the set of time-frequency resources includes a gain control message in accordance with the gain control configuration; and
transmit, via the set of time-frequency resources, the one or more signals in accordance with whether the set of time-frequency resources includes the gain control message.

2. The UE of claim 1, wherein the processing system is further configured to cause the UE to:
receive, from at least one of a network node or the second UE, an indication of the gain control configuration, wherein identifying the gain control configuration is associated with receiving the indication of the gain control configuration.

3. The UE of claim 2, wherein, to cause the UE to receive the indication of the gain control configuration, the processing system is configured to cause the UE to:
receive the indication of the gain control configuration via at least one of a downlink control information message or a sidelink control information message.

4. The UE of claim 1, wherein the processing system is further configured to cause the UE to:
receive, from a network node, an indication of a first gain control configuration,
wherein the gain control configuration includes a second gain control configuration that is different from the first gain control configuration.

5. The UE of claim 1, wherein the processing system is further configured to cause the UE to:
receive, from the second UE, feedback information associated with communications between the first UE and the second UE, wherein identifying the gain control configuration is associated with receiving the feedback information.

6. The UE of claim 1, wherein, to cause the UE to identify the gain control configuration, the processing system is configured to cause the UE to:
identify the gain control configuration in accordance with one or more parameters associated with communications between the first UE and the second UE.

7. The UE of claim 6, wherein the one or more parameters includes at least one of:
a modulation and coding scheme associated with the one or more signals,
a channel quality index,
a signal-to-noise ratio,
a reference signal received power,
a quality-of-service associated with the one or more signals,
a delay spread,
a received signal strength,
a decoding performance parameter, or
a reference signal received quality.

8. A method of wireless communication performed by a first user equipment (UE), comprising:
identifying a gain control configuration associated with a set of time-frequency resources for communicating one or more signals between the first UE and a second UE;
transmitting, to the second UE, an indication of whether the set of time-frequency resources includes a gain control message in accordance with the gain control configuration; and
transmitting, via the set of time-frequency resources, the one or more signals in accordance with whether the set of time-frequency resources includes the gain control message.

9. The method of claim 8, wherein the gain control configuration indicates whether a gain control procedure is to be applied to the set of time-frequency resources.

10. The method of claim 8, further comprising:
receiving, from a network node, an indication of a plurality of time-frequency resource sets for communications between the first UE and the second UE, wherein the gain control configuration indicates whether a gain control procedure is to be applied to each set of time-frequency resources of the plurality of time-frequency resource sets.

11. The method of claim 10, wherein the gain control configuration includes a bitmap.

12. The method of claim 10, wherein the gain control configuration indicates that the gain control procedure is to be applied to a first set of time-frequency resources of the plurality of time-frequency resource sets, and indicates that a subsequent set of time-frequency resources of the plurality of time-frequency resource sets is to be communicated independently of the gain control procedure.

13. The method of claim 8, wherein the set of time-frequency resources includes a time-frequency resource for communicating the gain control message.

14. The method of claim 8, wherein transmitting the one or more signals in accordance with whether the set of time-frequency resources includes the gain control message comprises:
transmitting at least one of a data message or a control message via a time-frequency resource, of the set of time-frequency resources, associated with the gain control message.

15. The method of claim 8, further comprising:
transmitting an indication of a second set of time-frequency resources for communicating an additional one or more signals in accordance with transmitting the one or more signals.

16. The method of claim 8, wherein transmitting the one or more signals in accordance with whether the set of time-frequency resources includes the gain control message comprises:
transmitting the gain control message via a time-frequency resource, of the set of time-frequency resources, associated with the gain control message.

17. An apparatus, comprising:
means for identifying a gain control configuration associated with a set of time-frequency resources for communicating one or more signals between the first UE and a second UE;
means for transmitting, to the second UE, an indication of whether the set of time-frequency resources includes a gain control message in accordance with the gain control configuration; and
means for transmitting, via the set of time-frequency resources, the one or more signals in accordance with whether the set of time-frequency resources includes the gain control message.

18. The apparatus of claim 17, further comprising:
means for transmitting a capability message indicating a capability of the first UE for identifying the gain control configuration.

19. The apparatus of claim 17, further comprising:
means for receiving a capability message indicating a capability of the second UE for receiving the one or more signals in accordance with whether the set of time-frequency resources includes the gain control message.

20. The apparatus of claim 17, further comprising:
means for transmitting, to the second UE, an indication of a quantity of time-frequency resources, of the set of time-frequency resources, for communicating the gain control message.
